(19) United States
(12) Patent Application Publication
(10) Pub. No.: US 2026/0142803 A1
(43) Pub. Date: May 21, 2026

(54) COLLECTIVE REMOTE ATTESTATION FRAMEWORK

(71) Applicant: CAMA Security, Inc., Sullivan's Island, SC (US)

(72) Inventors: Ross Philip Clarke, Sullivan's Island, SC (US); Tanishq Milind Borse, Rochester, NY (US)

(73) Assignee: CAMA Security, Inc., Sullivan's Island, SC (US)

(21) Appl. No.: 19/370,962

(22) Filed: Oct. 28, 2025

Related U.S. Application Data
(60) Provisional application No. 63/720,940, filed on Nov. 15, 2024.

(51) Int. Cl. H04L 9/08; H04L 9/14; H04L 9/32

(52) U.S. Cl. CPC H04L 9/0869; H04L 9/14; H04L 9/3236

(57) ABSTRACT

A method, apparatus, and computer-readable medium are described for secure management of sensor device authentication data. A processor may generate a unidirectional keychain by applying a one-way hash function to a seed, assign an epoch time, subdivide the epoch time into time intervals, and set a disclosure delay period. For each sensor device, the processor may assign a unique identifier and determine a set of private values comprising an authentication key, prover key, group key, sensor nonce, and hash value. The epoch time, time intervals, and private values may be stored on the sensor device.

### CROSS-REFERENCE TO RELATED APPLICATIONS

This application claims the benefit of priority from U.S. Provisional Application No. 63/720,940, filed on November 15, 2024, the entirety of which is hereby incorporated by reference.

### BACKGROUND

Sensor devices are increasingly deployed to monitor environments, infrastructure, and critical systems. With their proliferation, ensuring the trustworthiness and integrity of the data they collect has become a security concern. Attackers may target sensor nodes to inject false data or manipulate device behavior, threatening the overall reliability and security of the sensor network, including any devices and data.

### BRIEF SUMMARY

Embodiments of the present disclosure address the above needs and/or achieve other advantages by providing apparatuses and methods for a collective remote attestation framework.

A method includes initializing at least one verifier device and multiple sensor devices based in part on generating a unidirectional keychain, using a processor. The processor receives sensed data from the sensor devices, initiates an attestation cycle to verify each sensor device’s program memory, and determines, based on the attestation cycle, whether a first sensor device is not trusted. If the first sensor device is determined to be not trusted, the processor performs a corrective action.

A non-transitory computer-readable storage medium may include instructions that, when executed by a processor, cause the processor to perform the actions of initializing at least one verifier device and multiple sensor devices based at least in part on generating a unidirectional keychain, receiving sensed data from the sensor devices, initiating an attestation cycle to verify each sensor device’s program memory, determining whether a first sensor device is not trusted, and performing a corrective action in response.

An apparatus includes a processor and a memory that stores instructions. When these instructions are executed by the processor, the processor initializes at least one verifier device and multiple sensor devices, which involves generating a unidirectional keychain. The processor receives sensed data from the sensor devices and initiates an attestation cycle to verify the program memory of each sensor device. The processor then determines, based on the attestation cycle, that a first sensor device among the plurality of sensor devices is not trusted, and performs a corrective action related to this determination.

The features, functions, and advantages that have been described herein may be achieved independently in various embodiments of the present disclosure including computer-implemented methods, computer program products, and computing systems or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates a logic flow 500 in accordance with one embodiment.

FIG. 6 illustrates a logic flow 600 in accordance with one embodiment.

FIG. 7 illustrates a logic flow 700 in accordance with one embodiment.

FIG. 8 illustrates a logic flow 800 in accordance with one embodiment.

FIG. 9A–9B illustrate a logic flow 900 in accordance with one embodiment.

FIG. 10 illustrates a logic flow 1000 in accordance with one embodiment.

FIG. 11A–11B illustrate a logic flow 1100 in accordance with one embodiment.

FIG. 12 illustrates a computing system 1200 in accordance with one embodiment.

### DETAILED DESCRIPTION

Embodiments disclosed herein provide a framework for collective attestation of computing devices to verify the software executing on the computing devices. The devices may be any type of computing device, such as Internet-of-Things (IoT) devices, sensing devices, and the like. In some embodiments, the computing devices include embedded microcontroller units (MCUs). These embedded MCUs may support one or more threads of execution (e.g., may include one execution unit or processor core).

As examples, the devices may include microphone arrays that capture audio data, video cameras that capture image data, temperature sensors that capture temperature data, or any combination thereof. These devices may include device programs that are associated with the device functionality (e.g., a program to capture analog data, convert (or encode) the analog data to digital data, and transmit the digital data via a wireless communications interface). Embodiments disclosed herein may include a verification program that is configured to verify the integrity of the device program, e.g., to ensure the device program has not been modified and/or that the device program fully executes. By verifying the device programs that encode the data and transmit the data, an operator is able to determine if sensed data is corrupted.

During the verification process, the verification function, implemented in a Root-of-Trust on the device’s hardware (e.g., a hardware module such as a controller, circuit, etc.), checks the device program in device memory (which may be flash memory or any other type of memory). If the device program is not verified, the device is assumed to be compromised and any data transmitted by the device is assumed to be untrusted. Doing so allows for quick responses to detection of adversarial actions. For example, a verifier device implementing the verification program may determine that a first sensor device has been corrupted, and transmit an indication of the corruption, e.g., by outputting an indication in a user interface, transmitting an indication to another device via a network, etc.

More generally, embodiments disclosed herein provide features to implement the core functionality of a computing device and the collective attestation framework (or scheme). The solution may be delivered in two parts, including one or more complete pieces of software for each individual device (e.g., device programs), and a verifier program for a central verifier. In some embodiments, the verifier program may run on a small, single board computing device, such as a microcontroller. However, embodiments are not limited in these contexts.

For example, a microphone array may have a device program to capture and process audio data and a verification program to verify the device program. The device program may read analog data from each physical microphone, encode the analog data to a compressed digital data (which may be smaller in size than the analog data), and transmit the encoded data in chunks via a wireless communications interface, such as a Zigbee® radio. The verifier program may set up the microphone array, establish shared keys, and listen for sensed data from the microphones. In addition, both pieces of software implement functions to support the collective attestation function disclosed herein. These functions may include an interrupt attest function on the microphone device program along with attestation response aggregation. The verifier program may include a key chain setup, attest request functionality, and verification of responses. To keep overhead and computational complexity to a minimum, embodiments disclosed herein provide a simple to use text based user interface that provides control of the device (e.g., microphone array) to the operator. In addition, key metrics such as states of trust for each device may be shown in a consolidated view in a graphical user interface, making quick action easy for an operator.

Advantageously, embodiments disclosed herein provide continuous integrity monitoring, allowing for real-time detection of tampering or malicious changes throughout the lifecycle of each device. Doing so may mitigate the risk of undetected compromises that might occur between update cycles or during prolonged device usage. Furthermore, the absence detection mechanism disclosed herein may add an extra layer of security by identifying physically compromised devices, ensuring that any tampering or removal of hardware does not go unnoticed, enhancing the overall resilience of the system. The lightweight nature of embodiments disclosed herein may advantageously scale efficiently across large networks of resource constrained devices, such as Internet of Things (IoT) devices or microphone arrays, while maintaining minimal computational and communication overhead. Embodiments disclosed herein may be used in dynamic and/or distributed networks, as the decentralized attestation process ensures seamless security even in environments where devices are constantly joining or leaving the network.

Furthermore, embodiments disclosed herein may leverage collective attestation to enhance security, allowing devices to cross-validate each other’s integrity. This decentralized approach may prevent single points of failure and may ensure that any compromised device is detected through the attestation process. With real-time detection capabilities, embodiments disclosed herein significantly reduce the response time to security incidents, ensuring compromised devices are quickly identified and isolated, thus minimizing potential damage to the network and/or components thereof. Embodiments disclosed herein integrate seamlessly with existing infrastructure, enhancing security without the need for significant changes to existing systems. Such compatibility makes embodiments disclosed herein a cost-effective and easy-to-deploy solution for improving device integrity.

Aspects of the present disclosure and certain features, advantages, and details thereof are explained more fully below with reference to the non-limiting examples illustrated in the accompanying drawings. Descriptions of well-known processing techniques, systems, components, etc. are omitted so as to not unnecessarily obscure the disclosure in detail. It should be understood that the detailed description and the specific examples, while indicating aspects of the disclosure, are given by way of illustration only, and not by way of limitation. Various substitutions, modifications, additions, and/or arrangements, within the spirit and/or scope of the underlying concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

Unless described or implied as exclusive alternatives, features throughout the drawings and descriptions should be taken as cumulative, such that features expressly associated with some particular embodiments can be combined with other embodiments. Like numbers refer to like elements throughout.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the disclosure. Therefore, it is to be understood that, within the scope of the included claims, the disclosure may be practiced other than as specifically described herein.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present disclosure can include fixed function hardware, while other embodiments can utilize a software-based implementation of the functionality described. Certain embodiments combine both types of program code.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

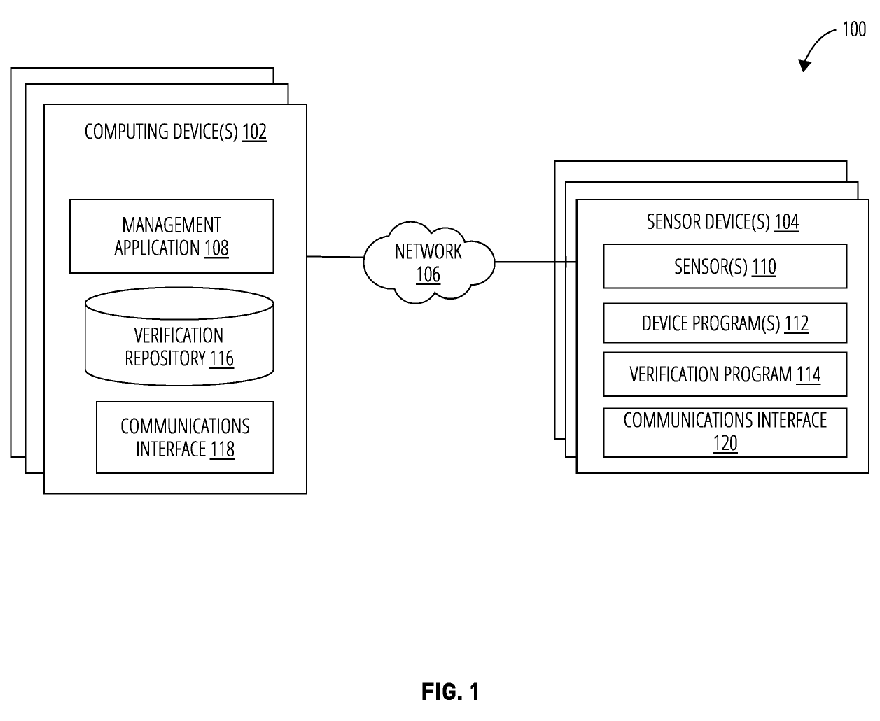

FIG. 1 illustrates a system 100 according to one embodiment. As shown, the system 100 includes one or more computing devices 102 and one or more sensor devices 104 communicably coupled via one or more networks 106. The computing devices 102 and sensor devices 104 each include at least one processor for executing instructions and at least one memory for storing instructions, each not pictured for the sake of clarity. The computing devices 102 represent any type of physical and/or virtualized computing device, such as a laptop, desktop, server, tablet, smartphone, etc.

A given computing device 102 and sensor device 104 may communicate using communications interface 118 and communications interface 120, respectively. The communications interface 118 and communications interface 120 are representative of any type of wired and/or wireless communications interface, e.g., wired Ethernet, wireless Ethernet, Wi-Fi, Zigbee, Bluetooth®, Thread, etc. Therefore, in some embodiments, the sensor devices 104 may communicate with other sensor devices 104 and/or the computing devices 102 via a mesh network.

The sensor devices 104 are representative of any type of physical computing device. In some embodiments, the sensor devices 104 are embedded devices, IoT devices, etc. Examples of sensor devices 104 therefore include audio sensing devices (e.g., microphones and/or microphone arrays), image sensing devices (e.g., cameras), temperature sensing devices, motion detecting devices, biometric monitoring devices, and/or any type of sensor device. As shown, the sensor devices 104 include one or more sensors 110 to sense data. Therefore, the sensors 110 may include one or more microphones and/or microphone arrays, one or more cameras, one or more temperature sensors (e.g., thermocouples, thermistors, infrared sensors, Resistance Temperature Detectors (RTDs), thermal imaging cameras, etc.), one or more motion detectors, and/or one or more biometric sensors (e.g., heartrate sensors, blood pressure sensors, fingerprint sensors, iris scanners, retina scanners, facial recognition scanners, etc.).

As shown, the sensor devices 104 include one or more device programs 112. A device program 112 generally represents executable code to perform processing functionalities associated with the sensor devices 104. For example, a device program 112 may include operations to process data sensed by the sensors 110, e.g., to read analog data captured by a sensor 110, encode the analog data to compressed digital data (which may be based on any encoding algorithm and/or compression algorithm), and transmit the encoded data in chunks via a communications interface 120. For example, a device program 112 of a sensor device 104 that includes one or more microphone arrays as sensors 110 may read analog audio data captured by the microphone arrays, encode the analog audio data into compressed audio data, and transmit the encoded audio data to one or more computing devices 102 or other sensor devices 104 via the communications interface 120. Although depicted as programs, the device programs 112 may be implemented as any type of executable code. For example, the device programs 112 represent firmware, applications, scripts, etc. Embodiments are not limited in these contexts.

Often, it may be desirable to verify the integrity of the sensor devices 104. For example, the sensor devices 104 may include security cameras and/or motion sensors of surveillance systems 100, environmental monitoring devices in environmental systems 100 (e.g., in a forest, park, etc.), microphones in professional recording studios, etc. However, sensor devices 104 may become corrupted, e.g., the device program 112 may become corrupted or otherwise execute incorrectly. For example, the device program 112 may include errors, e.g., a statically coded memory address is incorrect, which overwrites program memory (e.g., one or more portions of the device program 112) during execution. As another example, environmental elements may damage the hardware of the sensor devices 104 (e.g., water corrosion causes a short, which causes program memory to get overwritten), etc. As another example, malicious parties may exploit a sensor device 104 to cause the sensor device 104 to send false data (while remaining operational). Embodiments are not limited in these contexts, as a sensor device 104 may be corrupted or operate erroneously for any number and type of reason.

Advantageously, the sensor devices 104 include a verification program 114 to verify the device programs 112 using the collective attestation scheme described herein. Similarly, the computing devices 102 include a management application 108 that interfaces with the verification program 114, e.g., to send instructions, receive responses, etc. In some embodiments, the management application 108 and/or verification program 114 may set up the sensor devices 104 (e.g., set up the sensors 110), establish shared keys, and listen for sensed data from the sensors 110. In addition, the management application 108, verification program 114, and device programs 112 implement functions to support the collective attestation function disclosed herein. These functions may include an interrupt attest function and an attestation response aggregation function on the device program 112. The management application 108 and/or verification program 114 may include functions for key chain setup, attest request functionality, and verification of responses. To keep overhead and computational complexity to a minimum, the management application 108 and/or verification program 114 may provide a text based user interface that provides control of the sensor devices 104 to the operator. In addition, metrics such as states of trust for each sensor device 104 may be shown in a consolidated view on the computing device 102, making quick actions easy for an operator. For example, if the verification program 114 determines that a sensor device 104 is corrupted, the management application 108 may display an indication that sensor device 104 is corrupted on a display of the computing device 102. The management application 108 of the computing devices 102 may be the same or similar to the verification program 114 of sensor devices 104. In some embodiments, the management application 108 of the computing devices 102 includes additional features that are not included in the verification program 114 of the sensor devices 104, as the computing devices 102 are not as resource constrained as the sensor devices 104.

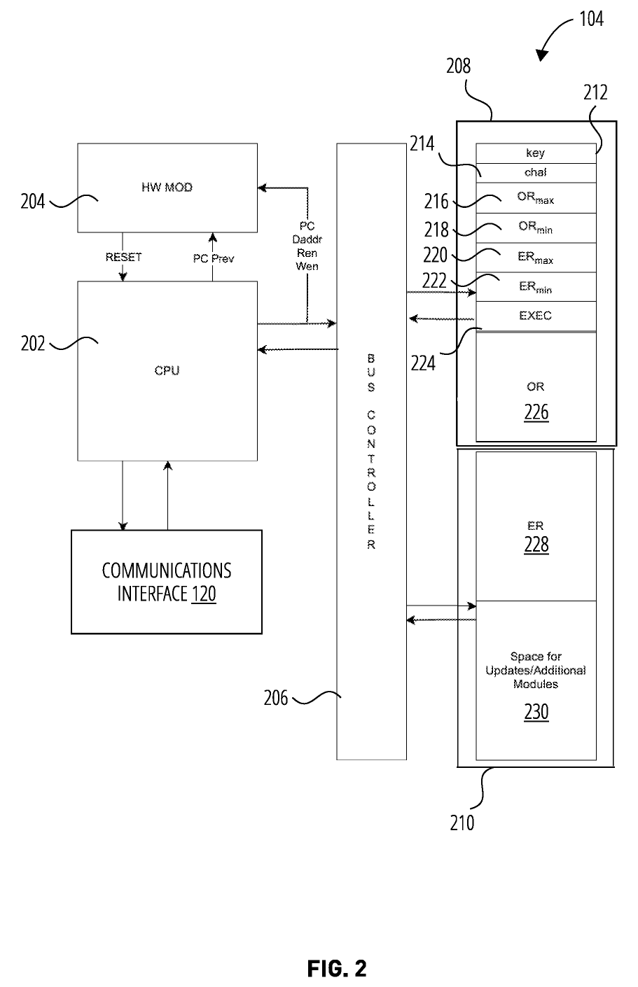

FIG. 2 illustrates an example of a sensor device 104, according to one embodiment. As shown, the sensor device 104 includes a processor 202, a hardware module 204, a bus controller 206, a flash memory 208, and a random access memory (RAM) 210. The processor 202 and hardware module 204 are representative of any type of processor circuit. In some embodiments, the hardware module 204 is a microcontroller. The microcontroller may support a single thread of execution (e.g., include a single core and/or execution unit). The flash memory 208 and the RAM 210 are representative of one or more memory devices. In some embodiments, the flash memory 208 may store the verification program 114 and/or device programs 112. In some embodiments, the RAM 210 is used by the verification program 114 and/or device programs 112 during execution. Although depicted as separate memory components, in some embodiments, the flash memory 208 and RAM 210 are integrated in a single memory device. In some embodiments, the sensor device 104 includes circuitry to compute hash values and/or MACs.

As shown, the flash memory 208 includes a key memory region 212 to store one or more keys, a challenge memory region 214 to store one or more challenges, a maximum output region 216, a minimum output region 218, a maximum execution region 220, a minimum execution region 222, an execution (EXEC) flag 224, and one or more output memory regions 226. The RAM 210 includes one or more execution regions 228 and additional memory 230. In some embodiments, the maximum output region 216 and minimum output region 218 are memory addresses that define a memory range of the output memory region 226 allocated to a device program 112. Similarly, in some embodiments, the key memory region 212 and challenge memory region 214 are addresses that define memory ranges in the flash memory 208. Furthermore, in some embodiments, the minimum execution region 222 and maximum execution region 220 are memory addresses that define a memory range in the RAM 210 allocated to a device program 112.

The attestation framework disclosed herein may satisfy at least the following security properties: (i) Safe Execution & Functionally Correct: ensures the device program 112 operates securely and correctly, free from tampering or malfunction, (ii) Immutability & Controlled Execution: guarantees the data collected by the sensors 110 and processed by the device program 112 and attestation processes provided by the verification program 114 are tamper-evident and execute in a controlled environment, (iii) Key Protection, Secure Key Access, & Confidentiality: safeguarding the cryptographic keys (which may be stored in the key memory region 212) used in attestation, ensuring that only authorized entities can access and use these keys, and (iv) allowing hardware (e.g., the sensor device 104) to monitor itself, which is set to ensure atomicity of the attest function.

The hardware module 204 may execute the verification program 114 to enforce the root of trust to verify the device program 112 (and/or the sensor device 104). The hardware module 204 acts as a monitor, ensuring various security properties are satisfied. Generally the hardware module 204 may prevent any reads from the key memory region 212 by the device program 112, unless the program counter (e.g., a pointer to a current instruction) of the device program 112 resides within the attest function. This may satisfy security property (i) above. Furthermore, the verification program 114 ensures only the attest function can read and write to the output memory region 226 by monitoring the data address line. If the data address line values reside within the memory space defined by the minimum output region 218 and maximum output region 216, but the program counter is not within the Execution Range (ER) memory space defined by the minimum execution region 222 and maximum execution region 220, a reset will be triggered and the EXEC flag 224 will be set to 0 signifying a potential compromise. This may satisfy security property (i).

The hardware module 204 may be used to monitor for attempted overwriting of the flash memory 208, e.g., in the ER memory range defined by maximum execution region 220 and minimum execution region 222. This ER range may be where the trusted binary (e.g., for the device program 112) is stored, meaning any attempts to overwrite this data would signify an attempt at manipulating the integrity of the device program 112. To do so, if a data address range is within the ER, “Wen” is true, and the program counter of the device program 112 is not within a trusted update function (e.g., a predefined region in the ER range where logic for updating itself resides), a reset will be triggered and EXEC flag 224 may be set to 0. This satisfies security property (ii). Furthermore, to ensure the control flow of the attest function (e.g., the verification program 114) runs from start to finish, any time the program counter of the device program 112 resides within the range of memory associated with the attest function, the hardware module 204 checks the previous PC. If this value is not within the range of memory associated with the attest function and the program counter is not at the starting instruction for the attest function, a reset is triggered and EXEC flag 224 is set to 0. In addition, if the program counter is pointing to an address in memory outside of the attest function, and the previous program counter is within the attest function, but not the last instruction, a reset is again triggered and the EXEC flag 224 is set to 0. This satisfies Security Property (iv), completing the security model.

The verification program 114 may implement the system setup functionality and the periodic request probes for attestation. In addition, the verification program 114 may act as a relay system to pass sensed data from all of the sensors 110 of all sensor devices 104 to a common location (e.g., to the management application 108 on one of the computing devices 102). A user interface of the management application 108 allows the operator to 1) initialize the attestation functionality, 2) generate a new key chain, 3) start an attestation request, and 4) check the status of all sensor devices 104.

The verification program 114 and/or the device program 112 for the sensor devices 104 are kept as simple and lightweight as possible to allow for a wide range of applications. Since the core functionality of a sensor device 104 is sensing data, the main portion of the software (e.g., the device program 112) implements sensing data. The device program 112 may cause analog data captured by a sensor 110 to be read in as a voltage stream from a single general purpose input/output (GPIO) pin and amplified by an analog to digital converter (not pictured) embedded in the hardware module 204. The device program 112 may cause the hardware module 204 to convert the amplified stream into 16-byte segments and encode the 16-byte segments using any suitable encoding scheme, such as the adaptive differential pulse-code modulation (ADPCM) encoding scheme. The device program 112 may cause the hardware module 204 to package the encoded data into one or more packets, e.g., for transmission and broadcasting via the communications interface 120. In addition to the data sensing, the device program 112 implements the attestation functionality needed on the hardware module 204. This may be implemented as an interrupt function that only runs when requested by the verification program 114 and/or the management application 108. In some embodiments, the request may be received via the network 106 from the management application 108 of the computing device 102. The attest function may update a nonce with the data in the attestation request. Then, one of two paths is taken. If the sensor device 104 has not generated a report, the report generation process is started. If a report was generated during the prior attestation cycle, the report is broadcasted back to the management application 108 of the computing device 102. In some embodiments, the report generation process consists of a two part function. First, a snapshot of program memory is taken. Then, the snapshot may be hashed with the nonce and a shared secret key. This report may be stored until the next attestation cycle.

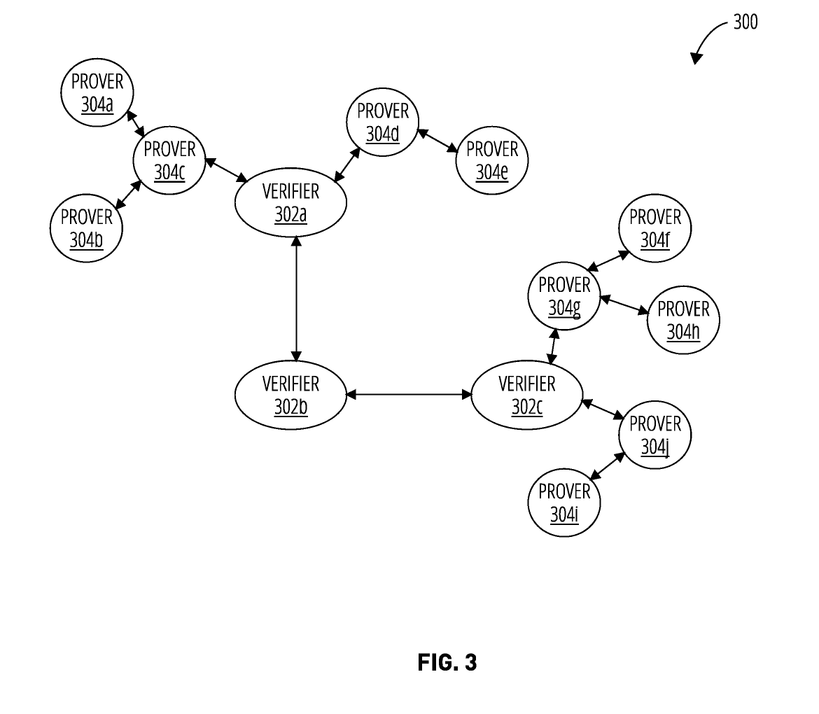

FIG. 3 depicts an example network topology 300 including a plurality of provers 304a-304j and a plurality of verifiers 302a-302c. In some embodiments, the sensor devices 104 are the provers 304a-304j. In some embodiments, the computing devices 102 are the verifiers 302a-302c. In some embodiments, a sensor device 104 acts as a verifier 302a-302c, e.g., to verify the firmware of the sensor devices 104. The firmware may include the device program 112 and/or the verification program 114. The particular network topology 300 depicted in FIG. 3 should not be considered limiting of the disclosure, as embodiments disclosed herein may be implemented in any type of network topology.

Provers 304a-304j, which include the sensor devices 104, may be responsible for proving the contents of their program memory, e.g., the flash memory 208, the device program 112, etc. The verifiers 302a-302c can be deployed on any networked device and are responsible for organizing periodic check-ins for the full network of provers 304a-304j. The verifiers 302a-302c also coordinate the validation of the attested software. In some embodiments, verifiers 302a-302c also can act as the key manager for the attestation scheme. Ultimately, the verifiers 302a-302c are the backbone of the collective attestation scheme and may be highly protected.

The provers 304a-304j may operate as either a leaf or an intermediate node in the network topology 300. The verification program 114 of the provers 304a-304j are responsible for relaying messages to any neighbor provers 304a-304j, as well as aggregating attestation responses for their neighborhood of provers 304a-304j.

One of the verifiers 302a-302c may act as the root node in the network topology 300. This verifier (e.g., using the management application 108) may be responsible for generating attestation requests that are sent to the provers 304a-304j, verifying attestation responses from provers 304a-304j, and keeping the operational time.

As stated, one or more sensor devices 104 may communicate using a mesh network. In the example depicted in FIG. 3, sensor devices 104, represented as provers 304a-304j, may communicate via a mesh network. For example, prover 304a may communicate with prover 304c, which in turn communicates with verifier 302a. Similarly, the verifiers 302a-302c may communicate with each other (e.g., via verification program 114), with one of the verifiers 302a-302c acting as a central verifier (e.g., the root node of the network). In the example depicted in FIG. 3, verifier 302a and verifier 302c report data back to verifier 302b acting as the central verifier. However, the management application 108 and/or verification program 114 of the verifier 302a, 302b, and/or 302c may transmit requests for attestation to the provers 304a-304j.

The disclosed attestation framework generally includes a prover 304a-304j using the verification program 114 to authenticate itself and its software configuration to one or more remote verifiers 302a-302c. Advantageously, the framework reduces the necessary overhead on the provers 304a-304j while maintaining real-time attestation capabilities. Through time-bound checks, the attestation framework attests the software running in program memory on provers 304a-304j (e.g., the flash memory 208 of sensor devices 104), and ensures the provers 304a-304j have remained alive.

The disclosed attestation framework may include an initialization phase and an attestation phase. In some embodiments, the initialization phase may be executed once, while the attestation phase may be invoked any number of times, e.g., using the management application 108 of the verifiers 302a-302c (and/or the verification program 114 of the provers 304a-304j). However, in some embodiments, the initialization phase may occur one or more times. In some embodiments, the initialization phase occurs in a secure environment, e.g., a lab, base, etc. For example, some or all of the initialization phase may be performed using the management application 108 on a computing device 102, which generates data and parameters, at least a portion of which may be stored in the sensor devices 104.

The management application 108 may initialize one or more of the verifiers 302a-302c. The initialization of the verifiers 302a-302c may include one or more of the verifiers 302a-302c (e.g., the verifier 302b serving as the root node in the network topology 300) generating a sequence of secret keys known as the Unidirectional Keychain (K). To do so, the management application 108 of verifier 302b may generate a random seed value. The seed value may be generated using any function. The seed value may be of any size. In some embodiments, the seed value is 256 bits and is generated using a cryptographically secure one‑way hash function such as the Secure Hash Algorithm (SHA) 256 function. The generated random seed may act as the first key K₀ in a keychain including keys K₀ through Kₙ, where n is any positive integer greater than 1. The verifier 302b may generate the subsequent keys (K₁ through Kₙ) by applying a cryptographically secure one‑way hash function (e.g., using a cryptographically secure one‑way hash function such as SHA 256) to the previous key. For example, the verifier 302b may hash key K₀ to generate K₁, hash K₁ to generate K₂, and so on.

The initialization phase may further include the management application 108 selecting an epoch time (T), where T is any positive integer, and the epoch time may be in any unit of time. In some embodiments, T is less than the time needed to perform a physical attack on the provers 304a-304j. In some embodiments, T is based on the time for one full attestation cycle to be completed. Therefore, the epoch time may be variable based on the type of the sensor devices 104, e.g., sensor devices 104 with more processing resources and/or faster network connections may complete an attestation cycle faster than sensor device 104 with fewer processing resources and/or slower network connections.

The epoch time may then be split into 4 unequal sub-intervals. For example, a 100 microsecond epoch time may be split into intervals of 10, 30, 50, and 20 microsecond sub-intervals. In some embodiments, a disclosure delay (d) may be determined by the management application 108. In some embodiments, the disclosure delay is long enough for transmission between all nodes in the network topology 300 (e.g., from the verifiers 302b to the furthest prover 304a-304j). In some embodiments, the disclosure delay time period may be determined (e.g., by the management application 108, the verifiers 302a-302c, the computing device 102, etc.) based on the amount of time required for transmission of data to the plurality of sensor devices 104. In some embodiments, the delay may be selected to ensure that broadcast messages, such as attestation requests or key releases, can be reliably received by all sensor devices 104 in the network before subsequent protocol steps are executed. The disclosure delay may be based on factors such as network topology, communication protocol (e.g., Zigbee, Wi-Fi), a count of the sensor devices 104, and/or observed transmission latencies. In some embodiments, the management application 108 may monitor transmission times during setup or operation and dynamically adjust the disclosure delay to accommodate changes in network conditions and/or device availability. For example, in one embodiment, the management application 108 may determine the disclosure delay by measuring the maximum round-trip transmission time of data transmitted between the computing device 102 (e.g., verifier 302b) and each sensor device 104 during network setup and/or a calibration phase. For example, if the maximum round-trip transmission time is 150 milliseconds, the disclosure delay may be set to 200 milliseconds.

In some embodiments, the management application 108 may select the disclosure delay based on prior stored transmission times (e.g., times previously determined to be required to broadcast data to the plurality of sensor devices 104). In some embodiments, the management application 108 may perform a calibration procedure that measures message propagation across the network and sets the epoch time to exceed the worst‑case measured propagation time (e.g., the longest measured time). In addition and/or alternatively, in some embodiments, the disclosure delay is based on the count of sensor devices 104 in the network.

The initialization may then include the verifier 302b generating starting nonce value, e.g., using a randomization function or any suitable function. The nonce value may be a 256-bit value, e.g., corresponding to the size of the size of the keys in the keychain.

The management application 108 may then be used to initialize the provers 304a-304j. To initialize the provers 304a-304j, one or more public values may be defined for and stored in each prover 304a-304j. The public values may include a prover identifier (ID), which may be any unique identifier. In some embodiments, the prover ID is a 16-bit identifier. A parent identifier (parentID) may be set to 0 for each prover 304a-304j (which may be updated when deployed). Furthermore, private values may be set for each prover 304a-304j. The private values may include a respective authentication key Kₐ for each prover 304a-304j, a respective Prover Key Kₚ for each prover 304a-304j, a group Key Kₙ for each prover 304a-304j (where Kₙ is the final generated key in the Unidirectional Keychain K). The private values may further include a respective nonce value for each prover 304a-304j, a stored hash H, where H is the hash of Kₚ and contents of program memory (e.g., the device program 112 and/or one or more portions of the flash memory 208). In some embodiments, operating values may be set for each prover 304a-304j (which may be private or public). The operating values may include the epoch time T and sub-interval times defined during initialization. As used herein, an integrity reference may include a hash value and/or a MAC.

The private values, e.g., the keys, may be unique to each prover 304a-304j and are therefore not disclosed. In some embodiments, the keys are stored in a read-only circuit, e.g., of the hardware module 204 and/or the flash memory 208, which has strict access controls.

The group key may also be secret/private. In some embodiments, the group key is shared across all the provers 304a-304j. The group key may be the final key generated in the unidirectional keychain generated by the verifier 302b. For example, if the unidirectional keychain generated by the verifier 302b includes 21 keys, the group key is the 21st key, e.g., Kₙ). As stated, the keychain and any other private values may be stored in a root of trust, e.g., a secure element of the sensor device 104, such as the hardware module 204 and/or a secure region of the flash memory 208.

In some embodiments, the initialization phase may be performed remotely, e.g., initialize provers 304a-304j without having to physically access these devices. Because the attestation function allows for key redistribution, private values (e.g., one or more keys such as the keychain and the group key) may be generated by the management application 108 of the verifiers 302a-302c. The verifiers 302a-302c transmit these keys to the provers 304a-304j in a secure manner.

The initialized sensor devices 104 may then be deployed in any suitable location. The device program 112 of the sensor devices 104 may then generate signed, encrypted data based on the data sensed by the sensors 110. For example, each sensor device 104 may send sensed data, signed with Kₐ, encrypted with the current key from K, and authenticated with hash of Kₙ and the current nonce value. The sensor devices 104 may then send the data via the communications interface 120, e.g., to another sensor device 104 and/or the management application 108 of the computing devices 102.

The attestation phase may occur at any time after deployment. A single pass of the attestation scheme may be referred to as an epoch. Depending on the configuration, one, many, or all of the provers 304a-304j may be attested during a given epoch. In some embodiments, each of the provers 304a-304j is included in the attestation phase for each epoch, ensuring presence and uptime. Each epoch may be broken up into four distinct time intervals of varying length, e.g., the sub-intervals defined during initialization. These time intervals may ensure proper synchronization between the verifiers 302a-302c and the provers 304a-304j, as well as ensuring constant uptime for the provers 304a-304j. Generally, if any of the provers 304a-304j do not respond and/or do not provide an expected response during one or more of the sub-intervals of the attestation phase, the verifiers 302a-302c may consider the provers 304a-304j to be corrupted or otherwise untrusted.

Generally, at initialization, each sensor device 104 is provisioned at initialization with the group key Kₙ, which is the final key in a unidirectional keychain K including keys K₀, K₁, ..., Kₙ generated by the verifier and/or computing device 102. Each attestation epoch may include: (i) during interval 1, the verifier broadcasts a random value N together with MAC(N, Kₙ₋₁); (ii) During interval 2, the verifier sends an encrypted attestation request R_{enc} along with MAC(R_{enc}, Kₙ₋₂) (without disclosing Kₙ₋₂); (iii) During interval 3, after a disclosure delay elapsing, the verifier discloses Kₙ₋₁, which devices use to authenticate the interval‑1 message and compute a refreshed nonce, nonce′ = H(nonce || N); (iv) during interval 3, after another disclosure delay elapsing, the verifier discloses Kₙ₋₂. The sensor devices 104 verify the integrity of the keychain by confirming the hash H(Kₙ₋₁) = Kₙ and the hash H(Kₙ₋₂) = Kₙ₋₁, derive the request encryption key K_{enc} = H(Kₙ₋₁ || nonce′), and use K_{enc} to decrypt R_{enc}. The decrypted request yields NNew, after which sensor devices 104 update the nonce to nonce″ = H(nonce′ || NNew). As used herein, H(·) denotes a cryptographically secure one‑way hash (e.g., SHA‑256), and MAC(·, K) denotes a message authentication code under key K. In some embodiments, for readability, K₁ ≡ Kₙ₋₁ and K₂ ≡ Kₙ₋₂; references to “K₁” and “K₂” may correspond to the keys disclosed after the group key Kₙ in the same epoch.

More specifically, each epoch may include the following operations. During the first time interval (e.g., the first sub-interval), a verifier such as verifier 302b produces a randomized value N, e.g., using a randomization function. The verifier 302b may then compute a Message Authentication Code (MAC) of N and the current key from the keychain K (note: if on first iteration, the current key is Kₙ₋₁). The MAC may be an authentication tag. The verifier 302b may broadcast N and the MAC to the verification program 114 of all provers 304a-304j. Each prover 304a-304j that receives the message within the current time interval, stores the message and forward the message to all neighboring provers 304a-304j. On receiving the message, each prover 304a-304j stores the sender’s ID as the parentID for the receiving prover 304a-304j. Therefore, the message may include a sender identifier (e.g., of the verifier 302b that generated the message and/or a prover 304a-304j that forwarded the message). Doing so allows each prover 304a-304j to identify their parent in the network topology 300. Stated differently, doing so builds up a bottom up spanning tree, where the root node does not know the tree, but the leaves know the path to the root node. The verifier 302b may then update its stored nonce by hashing the old nonce with N.

Advantageously, any device with the last key in the keychain cannot compute the previous key, but previous key can be used to compute the next key. Therefore, the verifiers 302a-302c are the only entities in the network topology 300 that can move back up the keychain.

At time interval 2 (e.g., the second sub-interval of the epoch), the verifier 302b may generate a randomized value NNew. The verifier 302b may then generate an attestation request R, which may include the random value NNew, a number of devices deployed (e.g., a count of the provers 304a-304j), and a verifier array identifying the provers 304a-304j required to compute their MAC (optional if compute skip is allowed). For example, if 50 provers 304a-304j exist in the network topology 300, the verifier array may have 50 elements. Each bit in the verifier array may indicate which provers 304a-304j must compute their MAC, e.g., based on whether the bit associated with the prover 304a-304j is set to 0 or 1. For example, if the 25th bit in the verifier array is set to 1, the prover 304a-304j having the unique ID of 25 must prove itself.

The verifier 302b may derive a symmetric encryption key K_{enc} based on a hash (e.g., using a cryptographically secure one‑way hash function such as SHA 256) of the next key in the keychain (Kₙₑₓₜ) and the current nonce. The verifier may then encrypt the request R with K_{enc}, thereby generating an encrypted request R_{enc}. The verifier 302b may then compute the MAC of R_{enc} and Kₙₑₓₜ and send the MAC value along with R_{enc} to the verification program 114 of all available provers 304a-304j, e.g., via a broadcast message.

The verification program 114 of each prover 304a-304j that receives the MAC within the current time interval stores the message in memory and forwards the message to all available provers 304a-304j. The verifier 302b may then update its nonce by hashing (e.g., using a cryptographically secure one‑way hash function such as SHA 256) the old nonce with NNew.

Time interval 3 (e.g., the third sub-interval of the epoch) may include waiting for the delay period d to elapse. The verifier 302b may then broadcast the current key in the keychain K_{cur} to each prover 304a-304j. The verification program 114 of each receiving prover 304a-304j may compute a hash of the received K_{cur} (e.g., using a cryptographically secure one‑way hash function such as SHA 256). If the hash is equal to the group key stored by the provers 304a-304j, K_{cur} is stored as K₁ by the verification program 114 of prover 304a-304j (e.g., stored as the next key in the keychain).

The verification program 114 of provers 304a-304j may then use K₁ to verify the value of nonce N, e.g., by computing a MAC of N using K₁ and comparing the computed MAC to the MAC received during interval 1. If nonce N is verified (e.g., the MAC comparison results in a match), the verification program 114 of prover 304a-304j computes a new nonce by hashing the old nonce with nonce N (e.g., using a cryptographically secure one‑way hash function such as SHA 256). After delay period d has elapsed (e.g., based on starting a timer), the verifier 302b may broadcast Kₙₑₓₜ to each prover 304a-304j. The verification program 114 of each receiving prover 304a-304j may store Kₙₑₓₜ and forward the Kₙₑₓₜ value to other available prover 304a-304j.

The verification program 114 of a receiving prover 304a-304j may send an acknowledgement to the device that sent the request (e.g., one of verifiers 302a-302c and/or provers 304a-304j). This may build a spanning tree with the verifier 302b as the root node of the tree. The verification program 114 of prover 304a-304j may then compute a hash of received Kₙₑₓₜ (e.g., using a cryptographically secure one‑way hash function such as SHA 256) and compare the computed hash to the stored K₁. If the comparison results in a match, Kₙₑₓₜ is stored as K₂ (e.g., the next key in the keychain) by the verification program 114 of prover 304a-304j.

The verification program 114 of prover 304a-304j may then use K₂ to compute MAC of K₂ and R_{enc}. If the computed MAC is equal to the received MAC, the verification program 114 of prover 304a-304j computes K_{enc} by hashing K₂ and the new nonce (e.g., using a cryptographically secure one‑way hash function such as SHA 256). The verification program 114 of prover 304a-304j may then use new K_{enc} to decrypt R_{enc}. To do so, the verification program 114 of prover 304a-304j creates two arrays size equal to the total number of provers 304a-304j, the first array storing a single bit at each index and the second array storing 256 bits at each index. In the first array, the verification program 114 of prover 304a-304j sets all values to 0 except the value corresponding to the ID of the associated prover 304a-304j, which is set to 1. For example, if prover 304a is prover 15 of 50 provers (and therefore has unique ID of 15), verification program 114 of prover 304a sets the index 15 of the first array to 1, and all other elements of the first array to zero. In the second array, the verification program 114 of prover 304a-304j sets all values to 0. If an array received in attestation request contains a 1 at the array position corresponding to the ID of the prover 304a-304j, then the verification program 114 of prover 304a-304j computes a hash of program memory and Kₚ (e.g., using a cryptographically secure one‑way hash function such as SHA 256). If the computed hash matches the stored hash H, the verification program 114 of prover 304a-304j sets value at array location corresponding to the ID of prover 304a-304j in the second array equal to the MAC of H and the updated nonce. Continuing the previous example, verification program 114 of prover 304a may set the 15th element of the second array equal to the computed MAC. If the attestation request’s array contains a 0, the hashing is skipped and the hash value H is assumed to be up to date.

In some embodiments, the creation of the first and second arrays is optional. For example, if the hash computed by the verification program 114 does not match the stored hash H, the verification program 114 may determine the corresponding sensor device 104 has been compromised and is not trusted. In such embodiments, the verification program 114 of sensor device 104 may perform a corrective action, e.g., transmitting an indication to the verifiers 302a-302c that the sensor device 104 is not trusted, not transmitting a response, shutting down or otherwise disabling the sensor device 104 and/or device program 112, transmitting a predetermined response (e.g., all zeros) to the verifiers 302a-302c, initiating a healing phase of the sensor device 104 (e.g., flashing the corrupted device program 112 with a trusted version of the device program 112), deleting one or more keys of the sensor device 104, etc.

Returning to the embodiment where the arrays are created, the verification program 114 of prover 304a-304j may then send both arrays to the prover 304a-304j associated with its parentID. For example, if the ID of prover 304d is set as the parent ID of prover 304e, verification program 114 of prover 304e sends its two arrays to prover 304d. A verification program 114 of prover 304a-304j that receives arrays from other provers 304a-304j may aggregate or otherwise combine the arrays. For example, the first array may be combined with received first arrays using the OR function, while the second array is combined with received second arrays using the exclusive or (XOR) function. The aggregated arrays are forwarded to the prover 304a-304j associated with the parentID of the aggregator. For example, the verification program 114 of prover 304d, which aggregated its first and second arrays with the first and second arrays of prover 304e, may provide the aggregated first and second arrays to verifier 302a, which is associated with the parentID of prover 304d.

At time interval 4 (e.g., the fourth sub-interval of the epoch), the root verifier 302b assumes all able provers 304a-304j have responded with their attestation, and that verifier 302a and 302c have merged all received responses into two arrays, which are transmitted to root verifier 302b. A given verifier 302a-302c may store the arrays in the verification repository 116.

For any value in the first array equal to 0, verifier 302b assumes the associated prover is untrusted. Any values set to 1 in the first array may be used as a liveness check. Stated differently, values set to 1 in the first array tells the verifier 302a-302c which provers 304a-304j responded to the attestation request and is used to short circuit the verification function. For example, refraining from further processing data associated with entries in the first array that are set to zero may cut the runtime complexity from n² to (n x (n-the number of zero entries in the first array)). For values in the first array equal to 1, for each remaining associated value in the second array, verifier 302b checks that the provided hash matches the expected value (the hash of the hash of the key of proverID at the current index and the expected program memory and the current nonce). The expected values for each prover 304a-304j (e.g., the sensor devices 104) may be stored in the verification repository 116. For any values not matching the expected value, the associated prover 304a-304j is determined to be untrusted. In some embodiments, a notification, alert, or other indication may be outputted for display on the verifier 302b or another device, e.g., one of the computing devices 102. As another example, an indication of the trusted and/or untrusted devices are stored in the verification repository 116, which may trigger an alert, etc. The verifier 302b may then update K_{cur} to be the key following Kₙₑₓₜ in the Unidirectional Keychain K.

The attestation phase may then be repeated any number of times, e.g., at periodic time intervals by the management application 108, based on user requests via the management application 108, etc. However, the number of epochs (e.g., the number of attestation phases) may be dependent on the size of the keychain.

The management application 108 may store indications of whether each of the sensor devices 104 are trusted or not trusted in the verification repository 116. A user may view the status of a given sensor device 104 using the management application 108. For example, the management application 108 may receive a request indicating one or more of the sensor devices 104. The management application 108 may reference the verification repository 116 to determine the status of each of the one or more sensor devices 104 specified in the request. The management application 108 may then output status indications on a display (e.g., whether each of the one or more sensor devices 104 is trusted or not trusted). In some embodiments, the management application 108 and/or verification program 114 may initiate a corrective action for sensor devices 104 determined to be not trusted, e.g., disabling untrusted sensor devices 104, dropping data received from untrusted sensor devices 104, initiating a healing phase of the sensor devices 104 (e.g., flashing the corrupted device program 112 with a trusted version of the device program 112), deleting keys of the sensor devices 104, etc.

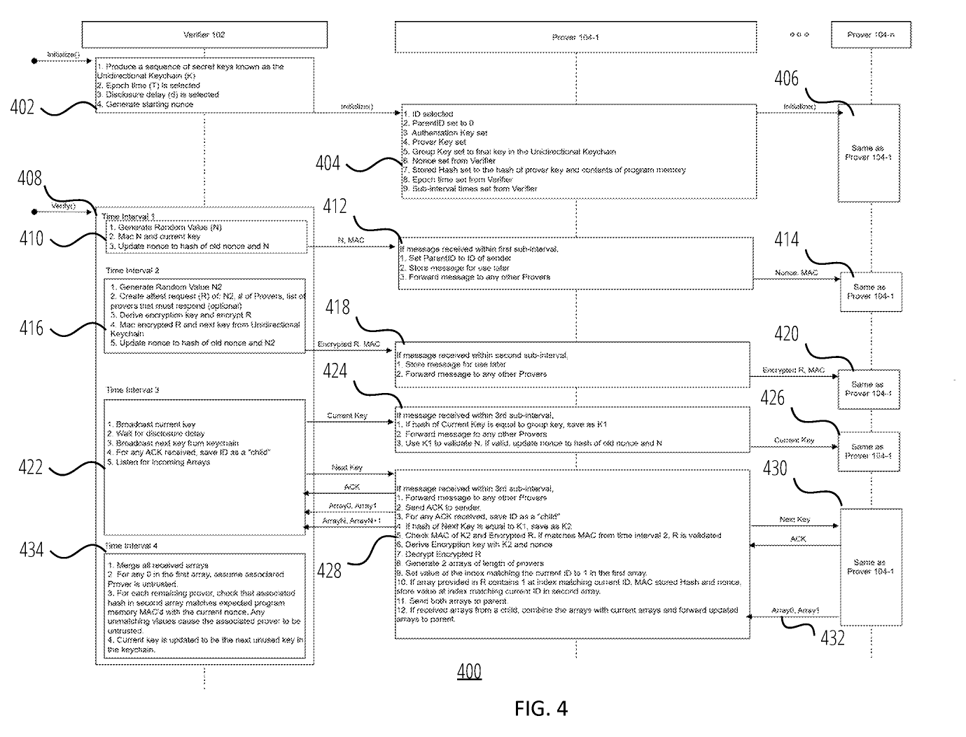

FIG. 4 illustrates an example sequence diagram 400 for a collective remote attestation framework, according to one embodiment. Although the example sequence diagram 400 depicts a particular sequence of operations, the sequence may be altered without departing from the scope of the present disclosure. For example, some of the operations depicted may be performed in parallel or in a different sequence that does not materially affect the function of the sequence diagram 400. In other examples, different components of an example device or system that implements the sequence diagram 400 may perform functions at substantially the same time or in a specific sequence.

As shown, the sequence diagram 400 includes operations performed by a verifier device such as computing device 102, a first prover device which may be a sensor device 104-1, and one or more other prover devices which may include one or more of sensor devices 104-n (where “n” is any positive integer greater than 1).

As shown, the initialization phase may begin at block 402. At block 402, the verifier 102 may produce a unidirectional keychain comprising a plurality of keys (K), determine an epoch time (e.g., based on user input, selecting one or more stored epoch times, or determining the epoch time), divide the epoch time into sub-intervals (e.g., four unequal sub-intervals of time), select a disclosure delay (e.g., based on user input, selecting one or more stored disclosure delay times, or determining the disclosure delay time), and compute a starting nonce value. In some embodiments, the verifier computing device 102 may store the unidirectional keychain (including the keys), the epoch time, the sub-intervals of time, the disclosure delay, and the starting nonce may be stored in the verification repository 116.

At block 404, the prover sensor device 104-1 may be initialized. For example, an ID value may be determined for sensor device 104-1, a parentID may be set to 0 for sensor device 104-1, an authentication key may be set for sensor device 104-1, a prover key may be set for sensor device 104-1, a group key may be set for sensor device 104-1 (which may be the final key in the unidirectional keychain), setting a nonce (e.g., which may be the same as the nonce computed for the verifier at block 402), a hash computed for sensor device 104-1 may include hashing the prover key and the contents of memory of the sensor device 104-1 and storing the hash in the sensor device 104-1, the epoch time may be set for the sensor device 104-1, and the subintervals may be set for the sensor device 104-1. The values may be stored in the sensor device 104-1 and the verification repository 116.

At block 406, one or more remaining sensor devices 104-n may be initialized using the operations in block 404 for the remaining sensor devices 104. At block 408, an attestation phase may commence. Although one attestation phase is depicted, any number of attestation phases may be completed. At block 410, which corresponds to the first sub-interval of the epoch time, the verifier computing device 102 may compute a random value N, compute a MAC of N and the current key from the unidirectional keychain, and update the nonce of the verifier computing device 102 to the hash of the old nonce and N. The N and MAC may be transmitted as a first message to prover sensor devices 104-1 through 104-n.

At block 412, the prover sensor device 104-1 may determine whether the first message is received within the first subinterval of time (e.g., based on a timer, the length of the first subinterval, etc.). If the first message is received within the first subinterval of time, the sensor device 104-1 may set its parentID to the ID of the sender (which may be specified in the first message), store the message, and forward the first message to any other prover sensor devices 104-n. Doing so allows the remaining prover sensor devices 104-n to perform the operations of block 412 at block 414 for the first subinterval of time.

At block 416, which corresponds to the second subinterval of time, the verifier computing device 102 may compute a random value N2 and create an attestation request R. The request R may include N2, the total number of prover sensor devices 104-1 through 104-n, and an array (or list) of prover sensor devices 104 that must complete the attestation phase. The verifier computing device 102 may further derive an encryption key and encrypt the request using the encryption key. The verifier computing device 102 may further compute a MAC of the encrypted request and the next key from the unidirectional keychain and update the nonce to the hash of the old nonce and N2.

The verifier computing device 102 may broadcast a second message including the encrypted request and the MAC computed at block 416. At block 418, the prover sensor device 104-1 may receive the second message and determine whether the second message is received during the second subinterval (e.g., based on a timer and a length of the second subinterval). If the second message is received during the second subinterval, the prover sensor device 104-1 may store the second message and forward the message to other prover sensor devices 104-n. At block 420, the remaining sensor devices 104-n may perform the operations at block 418, e.g., to receive, store, and forward the second message.

At block 422, which may correspond to the third subinterval of the current epoch, the verifier computing device 102 may broadcast a third message comprising the current key from the unidirectional keychain to the prover sensor devices 104-1 through 104-n and wait for an amount of time corresponding to the disclosure delay. At block 424 and 426, the sensor devices 104-1 through 104-n may receive the third message and determine whether the third message is received during the third subinterval (e.g., based on a timer and a length of the third subinterval). If the third message is received during the third subinterval, the prover sensor device 104-1 may compute a hash of the current key received in the third message and determine whether the hash is equal to the group key. If the hash equals the group key, the prover sensor device 104-1 stores the current key received in the third message as the next key K1 in the keychain. The sensor device 104-1 may use the key K1 to derive the nonce N of the sensor device 104-1 (e.g., by hashing the old nonce with the value N (e.g., the first random value sent in step 3 of time interval 1)). The sensor device 104 may then update its stored nonce to the hash of the old nonce and N. The sensor device 104-1 may forward the third message to other prover sensor devices 104-n, which may perform the steps of block 424 for the third subinterval.

Returning to block 422, the validator computing device 102 may determine the disclosure delay period has elapsed. The validator computing device 102 may then broadcast a fourth message including the next key from the unidirectional keychain. The validator computing device 102 may then wait for acknowledgments and/or arrays from the prover sensor devices 104-1 through 104-n. At block 428, the prover sensor device 104-1 receives the fourth message including the next key from the unidirectional keychain and determines whether the fourth message is received during the third subinterval (e.g., based on a timer and a length of the third subinterval). If the fourth message is received during the third subinterval, the prover sensor device 104-1 may forward the fourth message to other prover sensor devices 104-2 through 104-n, which may perform the steps of block 428 at block 430. Returning to block 428, the sensor device 104-1 may send an acknowledgment to the sender of the fourth message, e.g., the verifier computing device 102.

The prover sensor device 104-1 may receive acknowledgements from other prover sensor devices 104-2 through 104-n, e.g., based on forwarding the fourth message via the mesh network. The message may include a sender ID (e.g., of the sensor device 104-n, etc.), which may be stored as a child ID of the sensor device 104-1 (e.g., to build a spanning tree including all child nodes of the sensor device 104-1, e.g., one or more of sensor devices 104-2 through 104-n). The prover sensor device 104-1 may then compute a hash of the next key and determine whether the computed hash equals the stored key K1. If the computed hash matches K1, the next key is stored as K2 by the sensor device 104-1. The sensor device 104-1 may compute a MAC of K2 and the encrypted request R. If the MAC of K2 and encrypted request R matches the MAC received from the verifier at block 412, the request is validated.

The prover sensor device 104-1 may then derive the encryption key with K2 and the nonce (e.g., by hashing K2 and the nonce) and decrypt the encrypted request using the derived encryption key. The sensor device 104-1 may then generate a first array and a second array, where lengths of the first and second arrays equal the number of prover sensor devices 104-1 through 104-n. The prover sensor device 104-1 may set the value of the index matching the identifier of the sensor device 104-1 to 1. Furthermore, the sensor device 104-1 may determine whether the array in the decrypted request includes a value of 1 at the index matching the identifier of the sensor device 104-1. If the value of 1 exists at the index matching the identifier of sensor device 104-1, the sensor device 104-1 computes a MAC of the stored hash at nonce and stores the computed MAC at the index matching the identifier of sensor device 104-1 in the second array. If prover sensor device 104-1 receives arrays from other sensor devices 104-2 through 104-n (e.g., as shown at block 432), the sensor device 104-1 combines the first arrays using the OR function and combines the second arrays using the XOR function. The prover sensor device 104-1 may then transmit both arrays to the device associated with its parentID.

At block 434, the verifier computing device 102 may merge all received arrays, e.g., combines the first arrays using the OR function and combines the second arrays using the XOR function. For each entry with a zero value in the first array, the verifier computing device 102 determines that the associated prover sensor device 104 is untrusted. For each remaining prover sensor device 104, the verifier computing device 102 determines whether the hash in the second array matches a stored MAC of the expected program memory and the current nonce. If a match results, the associated prover sensor device 104 is determined to be trusted. If the comparison does not result in a match, the associated prover sensor device 104 is determined to be untrusted. Indications of trusted and/or untrusted sensor devices 104 may be transmitted to other devices, displayed on a display of the computing device 102, etc. Similarly, corrective actions may be initiated by the computing device 102, e.g., by disabling untrusted sensor devices 104, dropping data received from untrusted sensor devices 104, initiating a healing phase of the sensor devices 104 (e.g., flashing the corrupted device program 112 with a trusted version of the device program 112), deleting keys of the sensor device 104, etc. Embodiments are not limited in these contexts.

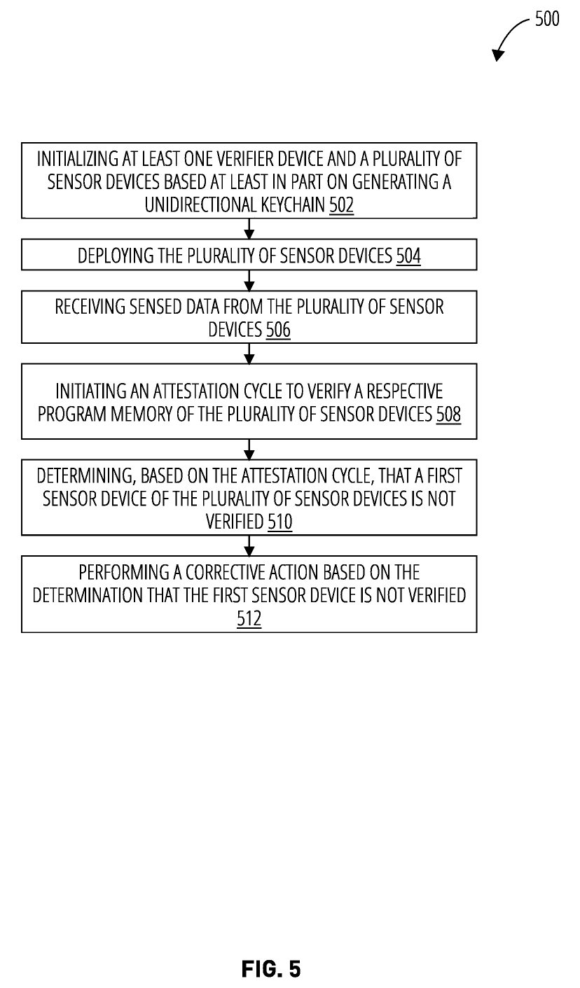

FIG. 5 illustrates an example logic flow 500. Although the example logic flow 500 depicts a particular sequence of operations, the sequence may be altered without departing from the scope of the present disclosure. For example, some of the operations depicted may be performed in parallel or in a different sequence that does not materially affect the function of the logic flow 500. In other examples, different components of an example device or system that implements the logic flow 500 may perform functions at substantially the same time or in a specific sequence.

According to some examples, the logic flow 500 includes initializing at least one verifier device and a plurality of sensor devices based at least in part on generating a unidirectional keychain at block 502. For example, the management application 108 may initialize at least one verifier device such as a computing device 102 and a plurality of sensor devices 104 based at least in part on generating a unidirectional keychain. In some embodiments, the computing device 102 executing the management application 108 may act as a verifier device.

According to some examples, the logic flow 500 includes deploying the plurality of sensor devices 104 at block 504.

According to some examples, the logic flow 500 includes receiving sensed data from the plurality of sensor devices at block 506. For example, the management application 108 may receive sensed data from the plurality of sensor devices 104.

According to some examples, the logic flow 500 includes initiating an attestation cycle to verify a respective program memory of the plurality of sensor devices 104 at block 508. For example, the management application 108 may initiate an attestation cycle to verify a respective program memory of the plurality of sensor devices.

According to some examples, the logic flow 500 includes determining, based on the attestation cycle, that a first sensor device of the plurality of sensor devices is not verified at block 510. For example, the management application 108 may determine, based on the attestation cycle, that a first sensor device 104 of the plurality of sensor devices 104 is not verified.

According to some examples, the logic flow 500 includes performing a corrective action based on the determination that the first sensor device is not verified at block 512. For example, the management application 108 may perform a corrective action based on the determination that the first sensor device 104 is not verified. For example, the management application 108 may generate an alert, transmit a notification to another device, disable the first sensor device 104, drop data received from the first sensor device 104, instruct the sensor device 104 to delete one or more keys, instruct the sensor device 104 to initiate a healing phase, etc. More generally, any number and type of operations may be performed when a device is not verified (or untrusted, or corrupted, etc.).

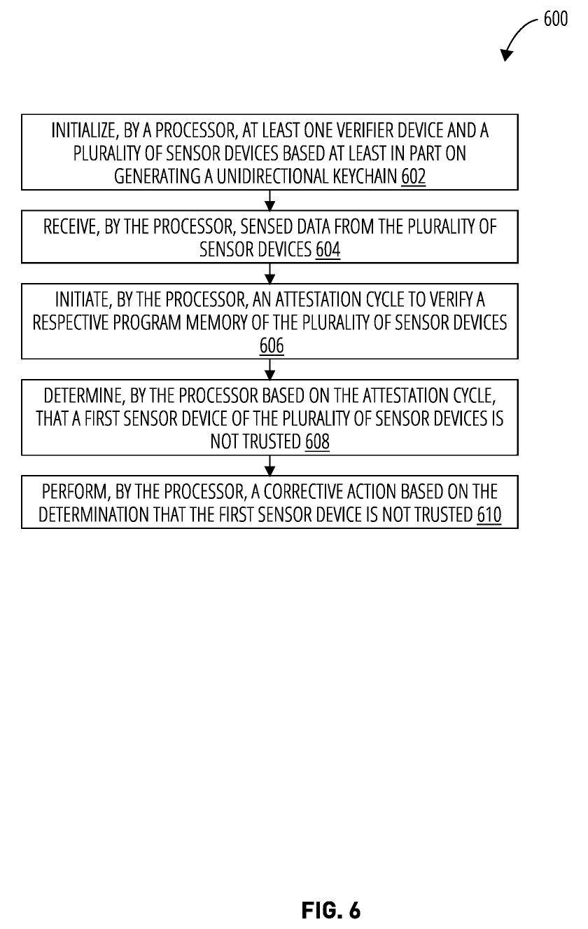

FIG. 6 illustrates an example logic flow 600 for a collective attestation framework. Although the example logic flow 600 depicts a particular sequence of operations, the sequence may be altered without departing from the scope of the present disclosure. For example, some of the operations depicted may be performed in parallel or in a different sequence that does not materially affect the function of the logic flow 600. In other examples, different components of an example device or system that implements the logic flow 600 may perform functions at substantially the same time or in a specific sequence.

According to some examples, the logic flow 600 includes initializing, by a processor, at least one verifier device and a plurality of sensor devices based at least in part on generating a unidirectional keychain at block 602. For example, the management application 108 may initialize at least one verifier device such as a computing device 102 and a plurality of sensor devices 104 based at least in part on generating a unidirectional keychain. In some embodiments, the computing device 102 executing the management application 108 may act as a verifier device.

According to some examples, the logic flow 600 includes receiving, by the processor, sensed data from the plurality of sensor devices at block 604. For example, the management application 108 may receive sensed data from the plurality of sensor devices 104.

According to some examples, the logic flow 600 includes initiating, by the processor, an attestation cycle to verify a respective program memory of the plurality of sensor devices at block 606. For example, the management application 108 may initiate an attestation cycle to verify a respective program memory of the plurality of sensor devices 104.

According to some examples, the logic flow 600 includes determining, by the processor based on the attestation cycle, that a first sensor device of the plurality of sensor devices is not trusted at block 608. For example, the management application 108 may determine, based on the attestation cycle, that a first sensor device 104 of the plurality of sensor devices 104 is not trusted.

According to some examples, the logic flow 600 includes performing, by the processor, a corrective action based on the determination that the first sensor device is not trusted at block 610. For example, the management application 108 may perform a corrective action based on the determination that the first sensor device 104 is not verified. For example, the management application 108 may generate an alert, transmit a notification to another device, disable the first sensor device 104, drop data received from the first sensor device 104, instruct the sensor device 104 to initiate a healing phase, instruct the sensor device 104 to delete one or more keys, etc. More generally, any number and type of operations may be performed when a device is not verified (or untrusted, or corrupted, etc.).

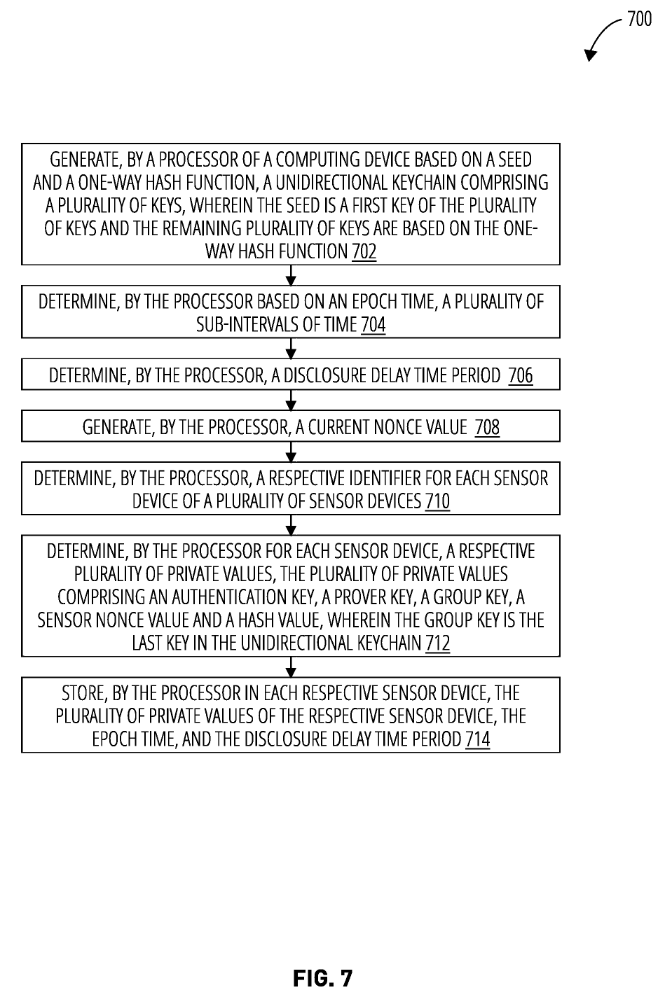

FIG. 7 illustrates an example logic flow 700 for an initialization phase. Although the example logic flow 700 depicts a particular sequence of operations, the sequence may be altered without departing from the scope of the present disclosure. For example, some of the operations depicted may be performed in parallel or in a different sequence that does not materially affect the function of the logic flow 700. In other examples, different components of an example device or system that implements the logic flow 700 may perform functions at substantially the same time or in a specific sequence.

According to some examples, the logic flow 700 includes generating, by a processor of a computing device based on a seed and a one-way hash function, a unidirectional keychain comprising a plurality of keys, wherein the seed is a first key of the plurality of keys, and the remaining plurality of keys are based on the one-way hash function at block 702. For example, the management application 108 may generate, based on a seed and a one-way hash function, a unidirectional keychain comprising a plurality of keys. The seed may be a first key of the plurality of keys. Each of the plurality of keys may be generated based on the one-way hash function.

According to some examples, the logic flow 700 includes determining, by the processor based on an epoch time, a plurality of sub-intervals of time at block 704. For example, the management application 108 may determine, based on an epoch time, a plurality of sub-intervals of time. The epoch time may be predetermined, selected by the management application 108 from a plurality of epoch times, etc. In some embodiments, the epoch time is based on a predetermined amount of time required to perform a physical attack on a sensor device 104.

According to some examples, the logic flow 700 includes determining, by the processor, a disclosure delay time period at block 706. For example, the management application 108 may determine a disclosure delay time period. The disclosure delay period may be predetermined and/or determined by the management application 108. For example, the management application 108 may determine an amount of time required to broadcast messages to the plurality of sensor devices 104 and set the disclosure delay time period to exceed the amount of time required to broadcast the messages to the sensor devices 104.

According to some examples, the logic flow 700 includes generating, by the processor, a current nonce value at block 708. For example, the management application 108 may generate a current nonce value.

According to some examples, the logic flow 700 includes determining, by the processor, a respective identifier for each sensor device of a plurality of sensor devices at block 710. For example, the management application 108 may determine and/or generate a respective unique identifier for each sensor device of a plurality of sensor devices.

According to some examples, the logic flow 700 includes determining, by the processor for each sensor device, a respective plurality of private values, the plurality of private values comprising an authentication key, a prover key, a group key, a sensor nonce value and a hash value, wherein the group key is the last key in the unidirectional keychain at block 712. For example, the management application 108 may determine, for each sensor device, a respective plurality of private values, the plurality of private values comprising an authentication key, a prover key, a group key, a sensor nonce value and a hash value, wherein the group key is the last key in the unidirectional keychain.

According to some examples, the logic flow 700 includes storing, by the processor in each respective sensor device, the plurality of private values of the respective sensor device, the epoch time, and the disclosure delay time period at block 714. For example, the management application 108 may store, in each respective sensor device 104, the plurality of private values of the respective sensor device, the epoch time, and the disclosure delay time period. Doing so may initialize the sensor devices 104.

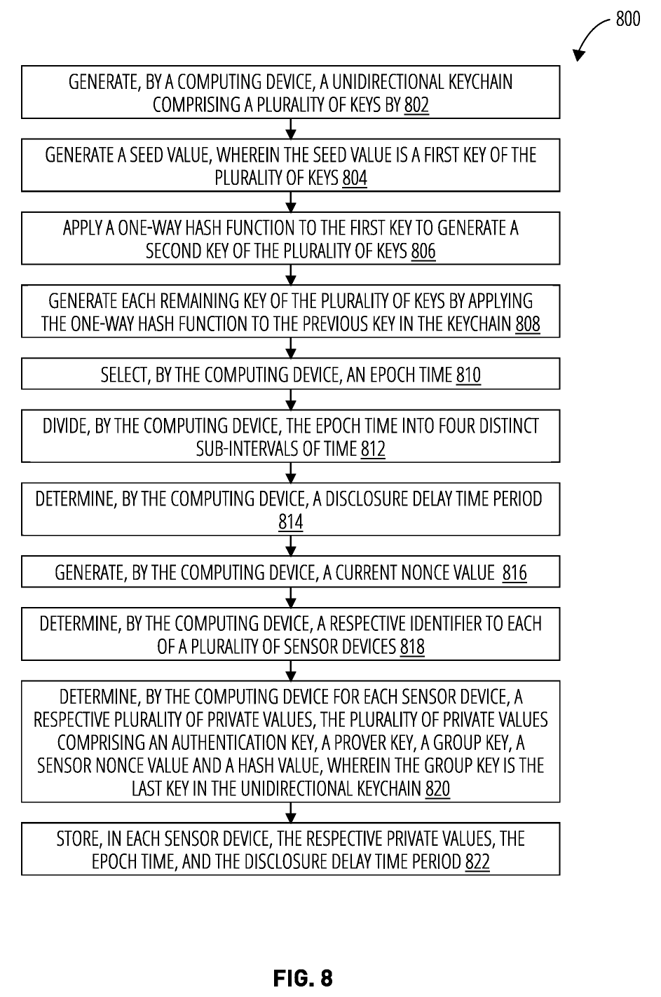

FIG. 8 illustrates an example logic flow 800 for an initialization phase. Although the example logic flow 800 depicts a particular sequence of operations, the sequence may be altered without departing from the scope of the present disclosure. For example, some of the operations depicted may be performed in parallel or in a different sequence that does not materially affect the function of the logic flow 800. In other examples, different components of an example device or system that implements the logic flow 800 may perform functions at substantially the same time or in a specific sequence.

According to some examples, the logic flow 800 includes generating, by a computing device, a unidirectional keychain comprising a plurality of keys by at block 802. For example, the management application 108 of computing device 102 may generate a unidirectional keychain comprising a plurality of keys.

According to some examples, the logic flow 800 includes generating a seed value, wherein the seed value is a first key of the plurality of keys at block 804. For example, the management application 108 of computing device 102 may generate a seed value, wherein the seed value is a first key of the plurality of keys.

According to some examples, the logic flow 800 includes applying a one-way hash function to the first key to generate a second key of the plurality of keys at block 806. For example, the management application 108 of computing device 102 may apply a one-way hash function to the first key to generate a second key of the plurality of keys.

According to some examples, the logic flow 800 includes generating each remaining key of the plurality of keys by applying the one-way hash function to the previous key in the keychain at block 808. For example, the management application 108 of computing device 102 may generate each remaining key of the plurality of keys by applying the one-way hash function to the previous key in the keychain.

According to some examples, the logic flow 800 includes selecting, by the computing device, an epoch time at block 810. For example, the management application 108 of computing device 102 may select an epoch time.

According to some examples, the logic flow 800 includes dividing, by the computing device, the epoch time into four distinct sub-intervals of time at block 812. For example, the management application 108 of computing device 102 may divide the epoch time into four distinct sub-intervals of time. For example, if the epoch time is 10 seconds, the four sub-intervals may be 2 seconds, 3 seconds, 4 seconds, and 1 second.

According to some examples, the logic flow 800 includes determining, by the computing device, a disclosure delay time period at block 814. For example, the management application 108 of computing device 102 may determine a disclosure delay time period. The delay may be based on the amount of time required for transmission of data to a plurality of sensor devices 104. Therefore, for example, the management application 108 may monitor the data transmission times to all of the sensor devices 104 over time, and determine the delay based on the monitoring.

According to some examples, the logic flow 800 includes generating, by the computing device, a current nonce value at block 816. For example, the management application 108 of computing device 102 may generate a current nonce value.

According to some examples, the logic flow 800 includes determining, by the computing device, a respective identifier to each of a plurality of sensor devices at block 818. For example, the management application 108 of computing device 102 may determine a respective identifier for each of a plurality of sensor devices such as sensor devices 104. The identifier may be any identifier that uniquely identifies the respective sensor device 104.

According to some examples, the logic flow 800 includes determining, by the computing device for each sensor device, a respective plurality of private values, the plurality of private values comprising an authentication key, a prover key, a group key, a sensor nonce value and a hash value, wherein the group key is the last key in the unidirectional keychain at block 820. For example, the management application 108 of computing device 102 may determine, for each sensor device 104, a respective plurality of private values, the plurality of private values comprising an authentication key, a prover key, a group key, a sensor nonce value and a hash value, wherein the group key is the last key in the unidirectional keychain.

According to some examples, the logic flow 800 includes storing, in each sensor device, the respective private values, the epoch time, and the disclosure delay time period at block 822. For example, the management application 108 of computing device 102 may store, in each sensor device 104, the respective private values, the epoch time, and the disclosure delay time period. In some embodiments, other devices may be used to program the data in the sensor devices 104.

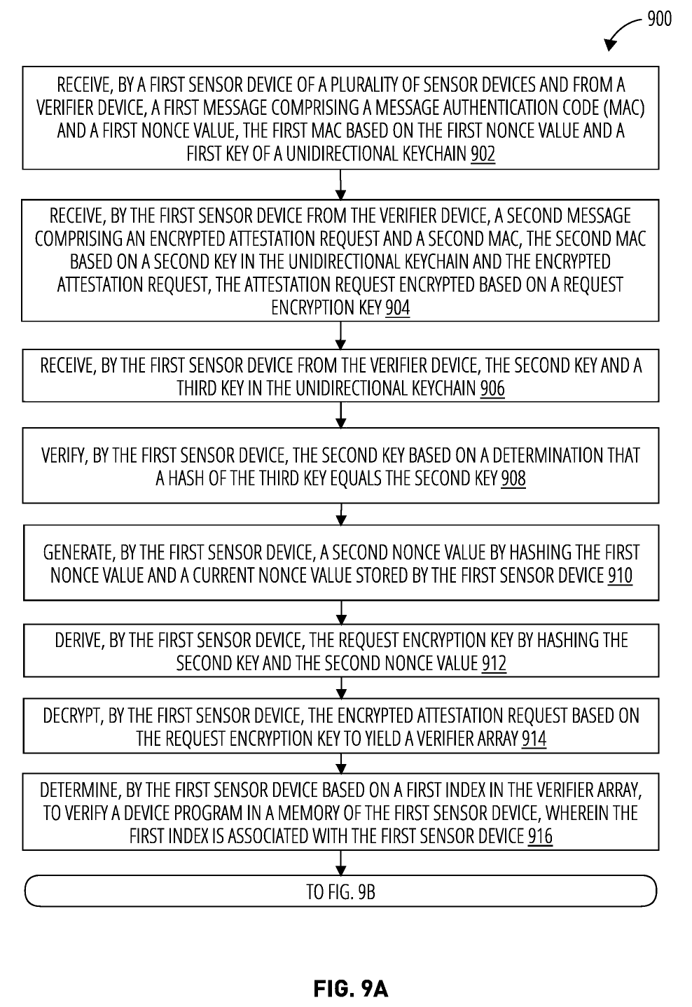

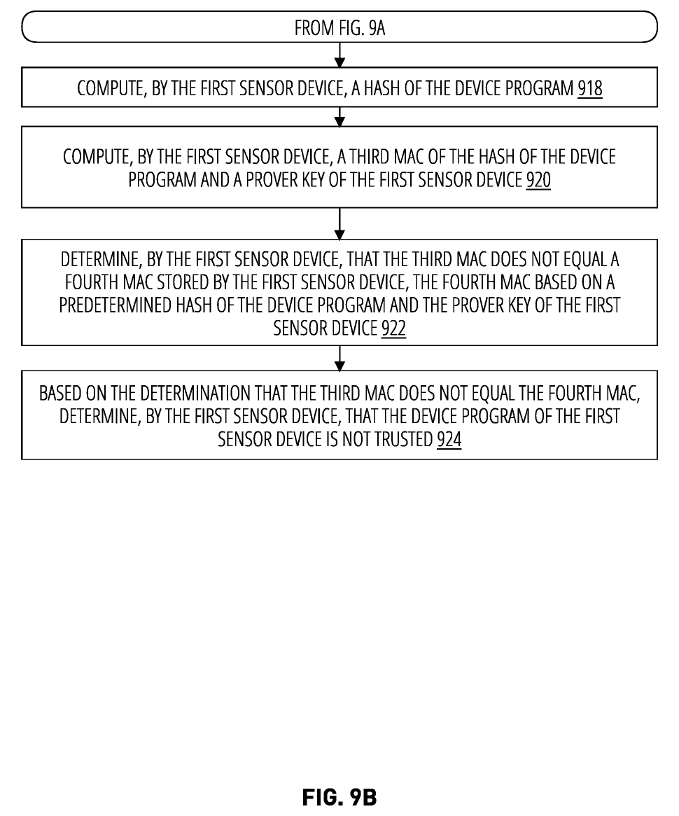

FIG. 9A-FIG. 9B illustrate an example logic flow 900 for at least a portion of an attestation phase from the perspective of a sensor device 104. Although the example logic flow 900 depicts a particular sequence of operations, the sequence may be altered without departing from the scope of the present disclosure. For example, some of the operations depicted may be performed in parallel or in a different sequence that does not materially affect the function of the logic flow 900. In other examples, different components of an example device or system that implements the logic flow 900 may perform functions at substantially the same time or in a specific sequence.

According to some examples, the logic flow 900 includes receiving, by a first sensor device of a plurality of sensor devices and from a verifier device, a first message comprising a message authentication code (MAC) and a first nonce value, the first MAC based on the first nonce value and a first key of a unidirectional keychain at block 902. For example, the verification program 114 of a first sensor device 104 may receive, from a verifier device, a first message comprising a message authentication code (MAC) and a first nonce value, the first MAC based on the first nonce value and a first key of a unidirectional keychain. The verifier device may be one of the computing devices 102 (including the management application 108) and/or one of the sensor devices 104 (including the verification program 114).

According to some examples, the logic flow 900 includes receiving, by the first sensor device from the verifier device, a second message comprising an encrypted attestation request and a second MAC, the second MAC based on a second key in the unidirectional keychain and the encrypted attestation request, the attestation request encrypted based on a request encryption key at block 904. For example, the verification program 114 of the first sensor device 104 may receive, from the verifier device, a second message comprising an encrypted attestation request and a second MAC, the second MAC based on a second key in the unidirectional keychain and the encrypted attestation request, the attestation request encrypted based on a request encryption key.

According to some examples, the logic flow 900 includes receiving, by the first sensor device from the verifier device, the second key and a third key in the unidirectional keychain at block 906. For example, the verification program 114 of the first sensor device 104 may receive, from the verifier device, the second key and a third key in the unidirectional keychain.

According to some examples, the logic flow 900 includes verifying, by the first sensor device, the second key based on a determination that a hash of the third key equals the second key at block 908. For example, the verification program 114 of the first sensor device 104 may verify the second key based on a determination that a hash of the third key equals the second key.

According to some examples, the logic flow 900 includes generating, by the first sensor device, a second nonce value by hashing the first nonce value and a current nonce value stored by the first sensor device at block 910. For example, the verification program 114 of the first sensor device 104 may generate a second nonce value by hashing the first nonce value and a current nonce value stored by the first sensor device.

According to some examples, the logic flow 900 includes deriving, by the first sensor device, the request encryption key by hashing the second key and the second nonce value at block 912. For example, the verification program 114 of the first sensor device 104 may derive the request encryption key by hashing the second key and the second nonce value.

According to some examples, the logic flow 900 includes decrypting, by the first sensor device, the encrypted attestation request based on the request encryption key to yield a verifier array at block 914. For example, the verification program 114 of the first sensor device 104 may decrypt the encrypted attestation request based on the request encryption key to yield a verifier array.

According to some examples, the logic flow 900 includes determining, by the first sensor device based on a first index in the verifier array, to verify a device program in a memory of the first sensor device, wherein the first index is associated with the first sensor device at block 916. For example, the verification program 114 of the first sensor device 104 may determine, based on a first index in the verifier array, to verify a device program in a memory of the first sensor device, wherein the first index is associated with the first sensor device.

Proceeding to FIG. 9B, according to some examples, the logic flow 900 includes computing, by the first sensor device, a hash of the device program at block 918. For example, the verification program 114 of the first sensor device 104 may compute a hash of the device program 112 and/or other portions of flash memory 208.

According to some examples, the logic flow 900 includes computing, by the first sensor device, a third MAC of the hash of the device program and a prover key of the first sensor device at block 920. For example, the verification program 114 of the first sensor device 104 may compute a third MAC of the hash of the device program 112 and a prover key of the first sensor device 104.

According to some examples, the logic flow 900 includes determining, by the first sensor device, that the third MAC does not equal a fourth MAC stored by the first sensor device, the fourth MAC based on a predetermined hash of the device program and the prover key of the first sensor device at block 922. For example, the verification program 114 of the first sensor device 104 may determine that the third MAC does not equal a fourth MAC stored by the first sensor device, the fourth MAC based on a predetermined hash of the device program and the prover key of the first sensor device.

According to some examples, the logic flow 900 includes, based on the determination that the third MAC does not equal the fourth MAC, determine, by the first sensor device, that the device program of the first sensor device is not trusted at block 924. For example, the verification program 114 of the first sensor device 104 may, based on the determination that the third MAC does not equal the fourth MAC, determine that the device program 112 of the first sensor device 104 is not trusted (e.g., corrupted, manipulated, etc.).

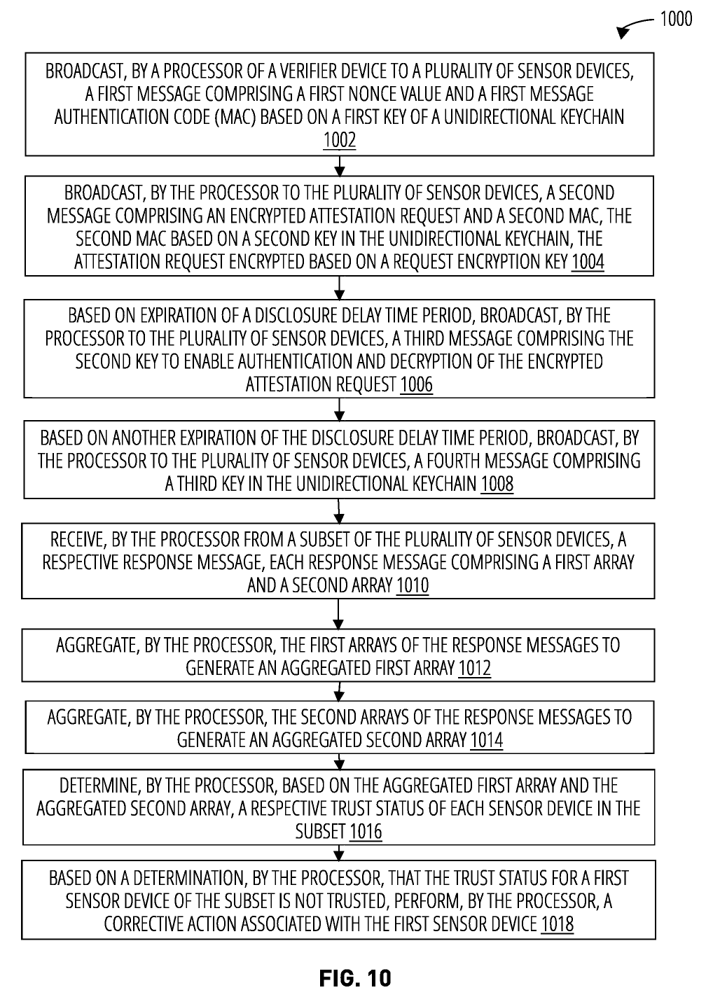

FIG. 10 illustrates an example logic flow 1000 for at least a portion of an attestation phase from the perspective of a verifier device. The verifier device may be a computing device 102 or a sensor device 104. Therefore, the logic flow 1000 may be performed by the management application 108 of a computing device 102 or the verification program 114 of a sensor device 104. Although the example logic flow 1000 depicts a particular sequence of operations, the sequence may be altered without departing from the scope of the present disclosure. For example, some of the operations depicted may be performed in parallel or in a different sequence that does not materially affect the function of the logic flow 1000. In other examples, different components of an example device or system that implements the logic flow 1000 may perform functions at substantially the same time or in a specific sequence.

According to some examples, the logic flow 1000 includes broadcasting, by a processor of a verifier device to a plurality of sensor devices, a first message comprising a first nonce value and a first message authentication code (MAC) based on a first key of a unidirectional keychain at block 1002. For example, the management application 108 may broadcast, to a plurality of sensor devices 104, a first message comprising a first nonce value and a first message authentication code (MAC) based on a first key of a unidirectional keychain.

According to some examples, the logic flow 1000 includes broadcasting, by the processor to the plurality of sensor devices, a second message comprising an encrypted attestation request and a second MAC, the second MAC based on a second key in the unidirectional keychain, the attestation request encrypted based on a request encryption key at block 1004. For example, the management application 108 may broadcast, to the plurality of sensor devices, a second message comprising an encrypted attestation request and a second MAC, the second MAC based on a second key in the unidirectional keychain, the attestation request encrypted based on a request encryption key.

According to some examples, the logic flow 1000 includes basing on expiration of a disclosure delay time period, broadcast, by the processor to the plurality of sensor devices, a third message comprising the second key to enable authentication and decryption of the encrypted attestation request at block 1006. For example, the management application 108 may, based on expiration of a disclosure delay time period, broadcast, by the processor to the plurality of sensor devices 104, a third message comprising the second key to enable authentication and decryption of the encrypted attestation request.

According to some examples, the logic flow 1000 includes basing on another expiration of the disclosure delay time period, broadcast, by the processor to the plurality of sensor devices, a fourth message comprising a third key in the unidirectional keychain at block 1008. For example, the management application 108 may, based on another expiration of the disclosure delay time period, broadcast, to the plurality of sensor devices 104, a fourth message comprising a third key in the unidirectional keychain.

According to some examples, the logic flow 1000 includes receiving, by the processor from a subset of the plurality of sensor devices, a respective response message, each response message comprising a first array and a second array at block 1010. For example, the management application 108 may receive, from a subset of the plurality of sensor devices 104, a respective response message, each response message comprising a first array and a second array.

According to some examples, the logic flow 1000 includes aggregating, by the processor, the first arrays of the response messages to generate an aggregated first array at block 1012. For example, the management application 108 may aggregate the first arrays of the response messages to generate an aggregated first array.

According to some examples, the logic flow 1000 includes aggregating, by the processor, the second arrays of the response messages to generate an aggregated second array at block 1014. For example, the management application 108 may aggregate the second arrays of the response messages to generate an aggregated second array.

According to some examples, the logic flow 1000 includes determining, by the processor, based on the aggregated first array and the aggregated second array, a respective trust status of each sensor device in the subset at block 1016. For example, the management application 108 may determine, based on the aggregated first array and the aggregated second array, a respective trust status of each sensor device 104 in the subset (e.g., sensor devices 104 that transmitted response messages).

According to some examples, the logic flow 1000 includes based on a determination, by the processor, that the trust status for a first sensor device of the subset is not trusted, perform, by the processor, a corrective action associated with the first sensor device at block 1018. For example, the management application 108 may, based on a determination that the trust status for a first sensor device 104 of the subset is not trusted, perform a corrective action associated with the first sensor device. For example, the management application 108 may generate an alert, transmit a notification to another device, disable the first sensor device 104, drop data received from the first sensor device 104, instruct the sensor device 104 to initiate a healing phase, instruct the sensor device 104 to delete one or more keys, etc. More generally, any number and type of operations may be performed when a device is not verified (or untrusted, or corrupted, etc.).

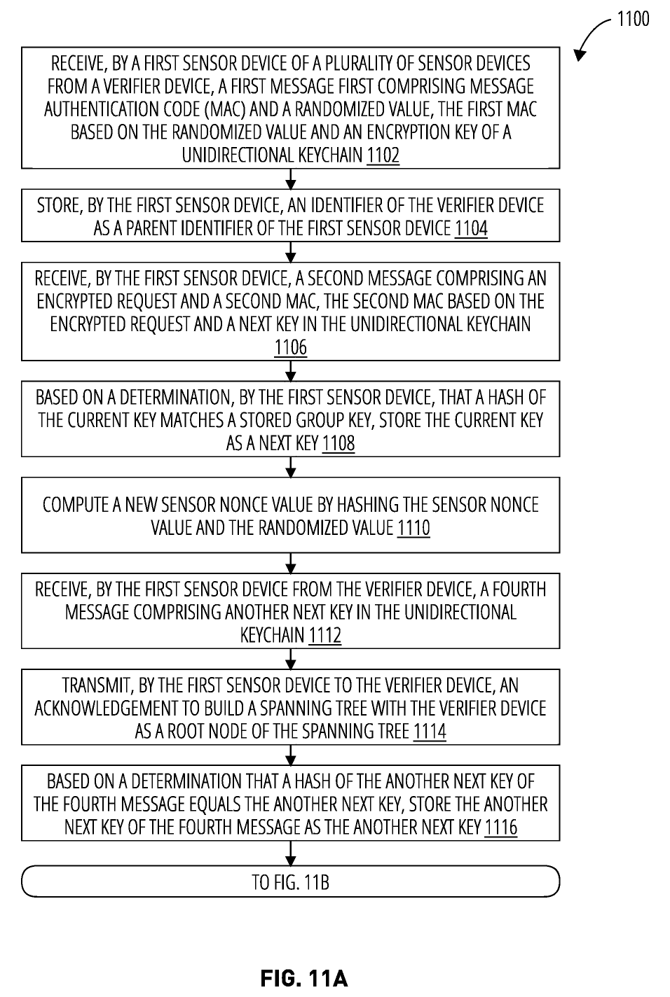

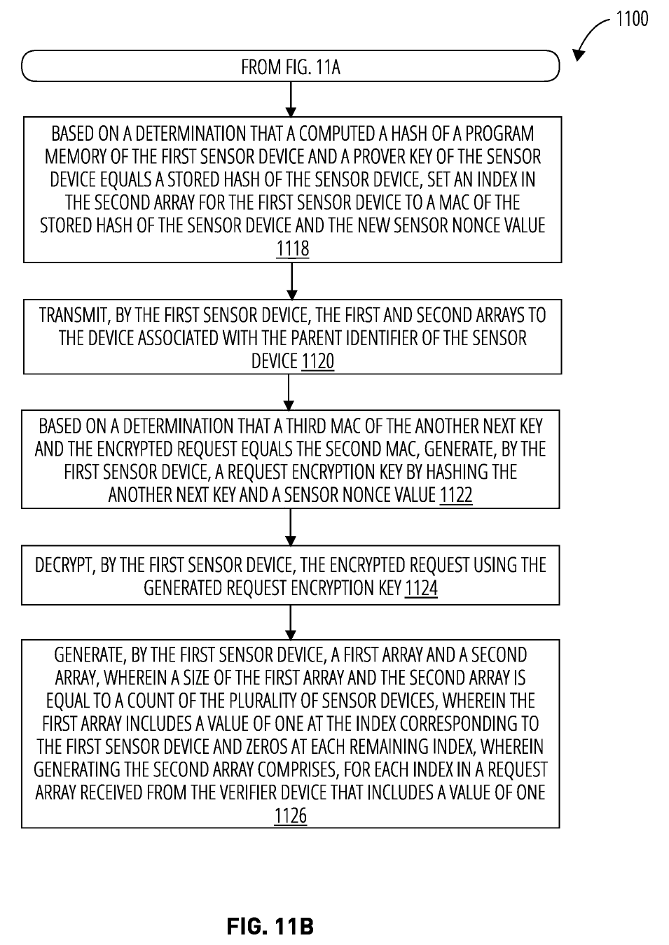

FIG. 11A illustrates an example logic flow 1100 for at least a portion of an attestation phase. Although the example logic flow 1100 depicts a particular sequence of operations, the sequence may be altered without departing from the scope of the present disclosure. For example, some of the operations depicted may be performed in parallel or in a different sequence that does not materially affect the function of the logic flow 1100. In other examples, different components of an example device or system that implements the logic flow 1100 may perform functions at substantially the same time or in a specific sequence. In some embodiments, the attestation includes fewer or more steps than the logic flow 1100.

According to some examples, the logic flow 1100 includes receiving, by a first sensor device of a plurality of sensor devices from a verifier device, a first message first comprising message authentication code (MAC) and a randomized value, the first MAC based on the randomized value and a first key of a unidirectional keychain at block 1102. For example, the sensor device 104 may receive, from a verifier device such as computing device 102 or verifier 302b, a first message first comprising message authentication code (MAC) and a randomized value, the first MAC based on the randomized value and an encryption key of a unidirectional keychain.

According to some examples, the logic flow 1100 includes storing, by the first sensor device, an identifier of the verifier device as a parent identifier of the first sensor device at block 1104. For example, the sensor device 104 may store an identifier of the verifier device as a parent identifier of the first sensor device.

According to some examples, the logic flow 1100 includes receiving, by the first sensor device, a second message comprising an encrypted request and a second MAC, the second MAC based on the encrypted request and a next key in the unidirectional keychain at block 1106. For example, the sensor device 104 may receive, from the computing device 102, a second message comprising an encrypted request and a second MAC, the second MAC based on the encrypted request and a next key in the unidirectional keychain.

According to some examples, the logic flow 1100 includes, based on a determination, by the first sensor device, that a hash of the current key matches a stored group key, store the current key as a next key at block 1108. For example, the sensor device 104 may, based on a determination, by the first sensor device, that a hash of the current key matches a stored group key, store the current key as a next key.

According to some examples, the logic flow 1100 includes, computing a new sensor nonce value by hashing the sensor nonce value and the randomized value at block 1110. For example, the sensor device 104 may compute a new sensor nonce value by hashing the sensor nonce value and the randomized value.

According to some examples, the logic flow 1100 includes receiving, by the first sensor device from the verifier device, a fourth message comprising another next key in the unidirectional keychain at block 1112. For example, the sensor device 104 may receive, from the verifier device (e.g., computing device 102), a fourth message comprising another next key in the unidirectional keychain.

According to some examples, the logic flow 1100 includes transmitting, by the first sensor device to the verifier device, an acknowledgement to build a spanning tree with the verifier device as a root node of the spanning tree at block 1114. For example, the sensor device 104 may transmit, to the computing device 102, an acknowledgement to build a spanning tree with the verifier device as a root node of the spanning tree.

According to some examples, the logic flow 1100 includes based on a determination that a hash of the another next key of the fourth message equals the another next key, storing the another next key of the fourth message as the another next key at block 1116. For example, the sensor device 104 may, based on a determination that a hash of the another next key of the fourth message equals the another next key, store the another next key of the fourth message as the another next key.

The logic flow 1100 may then proceed to FIG. 11B.

As shown, in FIG. 11B, according to some examples, the logic flow 1100 includes, based on a determination that a computed a hash of a program memory of the first sensor device and a prover key of the sensor device equals a stored hash of the sensor device, set an index in the second array for the first sensor device to a MAC of the stored hash of the sensor device and the new sensor nonce value at block 1118. For example, the sensor device 104 may, based on a determination that a computed a hash of a program memory of the first sensor device and a prover key of the sensor device equals a stored hash of the sensor device, set an index in the second array for the first sensor device to a MAC of the stored hash of the sensor device and the new sensor nonce value.

According to some examples, the logic flow 1100 includes transmitting, by the first sensor device, the first and second arrays to the device associated with the parent identifier of the sensor device at block 1120. For example, the sensor device 104 may transmit the first and second arrays to the device associated with the parent identifier of the sensor device (e.g., the computing device 102).

According to some examples, the logic flow 1100 includes, based on a determination that a third MAC of the another next key and the encrypted request equals the second MAC, generating, by the first sensor device, a request encryption key by hashing the another next key and a sensor nonce value at block 1122. For example, the sensor device 104 may, based on a determination that a third MAC of the another next key and the encrypted request equals the second MAC, generate a request encryption key by hashing the another next key and a sensor nonce value.

According to some examples, the logic flow 1100 includes decrypting, by the first sensor device, the encrypted request using the generated request encryption key at block 1124. For example, the sensor device 104 may decrypt the encrypted request using the request encryption key generated at block 1122.

According to some examples, the logic flow 1100 includes generating, by the first sensor device, a first array and a second array, wherein a size of the first array and the second array is equal to a count of the plurality of sensor devices, wherein the first array includes a value of one at the index corresponding to the first sensor device and zeros at each remaining index, wherein generating the second array comprises, for each index in a request array received from the verifier device that includes a value of one at block 1126. For example, the sensor device 104 may generate a first array and a second array, wherein a size of the first array and the second array is equal to a count of the plurality of sensor devices, wherein the first array includes a value of one at the index corresponding to the first sensor device and zeros at each remaining index, wherein generating the second array comprises, for each index in a request array received from the verifier device that includes a value of one.

In some embodiments, a method, includes initializing, by a processor, at least one verifier device and a plurality of sensor devices based at least in part on generating a unidirectional keychain, receiving, by the processor, sensed data from the plurality of sensor devices, initiating, by the processor, an attestation cycle to verify a respective program memory of the plurality of sensor devices, determining, by the processor based on the attestation cycle, that a first sensor device of the plurality of sensor devices is not trusted, and performing, by the processor, a corrective action based on the determination that the first sensor device is not trusted. The method may also include where performing the corrective action includes one or more of: generating an alert, transmitting a notification to another device, disabling the first sensor device, or dropping data received from the first sensor device. The method may also include where the initialization includes generating, by the processor, the unidirectional keychain includes a plurality of keys by generating, by the processor, a seed value, where the seed value is a first key of the plurality of keys, applying, by the processor, a one-way hash function to the first key to generate a second key of the plurality of keys, and generating, by the processor, each remaining key of the plurality of keys by applying the one-way hash function to the previous key in the keychain.

The method may also include where the initialization further includes selecting, by the processor, an epoch time, dividing, by the processor, the epoch time into a plurality of sub-intervals of time, determining, by the processor, a disclosure delay time period, and generating, by the processor, a current nonce value. The method may also include where the initialization further includes determining, by the processor, a respective identifier for each of the sensor devices, determining, by the processor for each sensor device, a respective plurality of private values, the plurality of private values includes an authentication key, a prover key, a group key, a sensor nonce value and a hash value, where the group key is a last key in the unidirectional keychain, and storing, in each sensor device, the respective private values, the epoch time, and the disclosure delay time period. The method may also include where the attestation cycle includes, at a first sub-interval of time of the plurality of sub-intervals of time generating, by the processor, a new value, generating, by the processor, a message authentication code (MAC) based on the new value and a current key of the plurality of keys of the unidirectional keychain, broadcasting, by the processor via a network interface, a first message includes the new value and the MAC to at least a subset of the plurality of sensor devices, where at least a second sensor device of the plurality of sensor device forwards the first message to a third sensor device of the plurality of sensor devices via a mesh network, where each sensor device that receives the first message during the first sub-interval: (i) stores the first message in memory, (ii) forwards the first message to neighboring sensor devices via the mesh network, and (iii) stores the identifier of the sensor device from which the first message was received as a parent identifier, and updating, by the processor, the current nonce value by hashing the current nonce value and the new value.

The method may also include where the attestation cycle includes, at a second sub-interval of time of the plurality of sub-intervals of time generating, by the processor, another new value, generating, by the processor, an attestation request includes the another new value, a count of the plurality of sensor devices, and a request array includes a plurality of elements, where respective elements of the request array are associated with respective ones of the plurality of sensor devices and indicate whether the associated sensor device needs to perform an attestation, deriving, by the processor, a request encryption key based on computing a hash of the next key in the unidirectional keychain and the current nonce value, encrypting, by the processor based on the request encryption key, the attestation request, computing, by the processor, a MAC of the encrypted attestation request and the next key in the unidirectional keychain, transmitting, by the processor to at least a subset of the sensor devices, a second message includes the encrypted attestation request and the MAC of the encrypted attestation request and the next key in the unidirectional keychain, where the subset of sensor devices receiving the second message stores the second message and forwards the second message to other sensor devices, and updating, by the processor, the current nonce value by hashing the current nonce value and the another new value.

The method may also include where the at least one verifier device includes the processor, where the attestation cycle includes, at a third sub-interval of time of the plurality of sub-intervals of time determining, by the processor based on a timer, that the disclosure delay time period has elapsed. The initialization further may include broadcasting, by the processor via the network interface based on the disclosure delay time period elapsing, a third message includes a current key from the keychain, where each sensor device that receives the third message determines whether a hash of the current key of the third message equals the group key, based on a determination that the hash of the current key of the third message equals the group key, stores the current key of the third message as a next key, verifies the first message based on determining a MAC of the first nonce value using the next key equals the first MAC, and computes a new sensor nonce value by hashing the sensor nonce value with the new value. The initialization further may include determining, by the processor based on the timer, that the disclosure delay time period has elapsed another time; broadcasting, by the processor via the network interface, a fourth message includes the next key in the unidirectional keychain. The initialization further may include receiving, by the processor from a first sensor device of the subset of the sensor devices and via the network interface, a first array and a second array, where a size of the first array and a size of the second array are equal to the count of the plurality of sensor devices, where the first array stores one bit at each index and the second array stores a predetermined number of bits at each index; determining, by the processor, sensor devices associated with values of zero in the first array are not trusted. The method may also include where the attestation cycle includes, at a fourth sub-interval of time of the plurality of sub-intervals of time combining, by the processor, all received first arrays using the OR function. The initialization further may include combining, by the processor, all received second arrays using the XOR function. The initialization further may include determining, by the processor, each sensor device associated with values of zero in the first array is not trusted. The initialization further may include for sensor devices associated with values of one in the first array determining, by the processor, whether the hash in the corresponding entry of the second array matches an expected value, where the expected value includes the hash of the hash of the key at the associated index of the second array and the expected program memory and the current nonce value, determining, by the processor for each hash in the corresponding entry of the second array that matches the expected value, that the associated sensor device is trusted, and determining, by the processor for each hash in the corresponding entry of the second array that does not match the expected value, that the associated sensor device is not trusted.

The initialization further may include setting, by the processor, a next key in the unidirectional keychain as the current key. The method may also include further includes, for each sensor device that receives the fourth message storing, by a processor of the respective sensor device, the next key in the fourth message and forwards the fourth message to other sensor devices. The initialization further may include sending, by the processor of the respective sensor device, an acknowledgement of the fourth message to the device from which the fourth message was received to build a spanning tree with the at least one verifier device as a root node of the spanning tree. The initialization further may include storing, by the processor of the respective sensor device based on a determination that a hash of the next key of the fourth message equals the stored next key, the next key of the fourth message as the next key. The initialization further may include based on a determination, by the processor of the respective sensor device, that a MAC of the next key and the encrypted attestation request equals the MAC of the second message, generating the request encryption key by hashing the next key and the new sensor nonce value.

The initialization further may include decrypting, by the processor of the respective sensor device, the encrypted attestation request using the generated request encryption key. The initialization further may include generating, by the processor of the respective sensor device, the first array and the second array, where the first array includes a value of one at the index corresponding to the respective sensor device and zeros at each remaining index, where generating the second array includes setting each index in the second array to zero values; for each index in the request array that includes a value of one computing a hash of a program memory of the sensor device and the prover key of the sensor device, and based on a determination that the hash of the program memory of the sensor device and the prover key of the sensor device equals the stored hash of the sensor device, setting the corresponding index in the second array to a MAC of the stored hash of the sensor device and the new sensor nonce value. The initialization further may include generating, by the processor of the respective sensor device, the first array and the second array, where the first array includes a value of one at the index corresponding to the respective sensor device and zeros at each remaining index, where generating the second array includes combining, by the processor of the respective sensor device, the first array with a first array received from other sensor devices using the OR function. The initialization further may include generating, by the processor of the respective sensor device, the first array and the second array, where the first array includes a value of one at the index corresponding to the respective sensor device and zeros at each remaining index, where generating the second array includes combining, by the processor of the respective sensor device, the second array with a second array received from other sensor devices using the XOR function. The initialization further may include generating, by the processor of the respective sensor device, the first array and the second array, where the first array includes a value of one at the index corresponding to the respective sensor device and zeros at each remaining index, where generating the second array includes transmitting, by the processor of the respective sensor device, the combined first and second arrays to the device associated with the parent identifier of the respective sensor device.

In some embodiments, a method comprises generating, by a processor of a computing device based on a seed and a one-way hash function, a unidirectional keychain includes a plurality of keys, where the seed is a first key of the plurality of keys and the remaining plurality of keys are based on the one-way hash function, determining, by the processor based on an epoch time, a plurality of sub-intervals of time, determining, by the processor, a disclosure delay time period, generating, by the processor, a current nonce value, determining, by the processor, a respective identifier for each sensor device of a plurality of sensor devices, determining, by the processor for each sensor device, a respective plurality of private values, the plurality of private values includes an authentication key, a prover key, a group key, a sensor nonce value and a hash value, where the group key is the last key in the unidirectional keychain, and storing, by the processor in each respective sensor device, the plurality of private values of the respective sensor device, the epoch time, and the disclosure delay time period. The method may also include where generating the unidirectional keychain includes applying, by the processor, the one-way hash function to the first key to generate a second key of the plurality of keys.

The method may also include where the disclosure delay time period is based on an amount of time required for transmission of data to the plurality of sensor devices via one or more networks. The method may also include further includes determining, by the processor, the epoch time based on an amount of time required to perform a physical attack on the sensor devices. The method may also include where the plurality of private values of the respective sensor device, the epoch time, and the disclosure delay time period are stored in a secure memory region or a secure element of the respective sensor device. The method may also include where the plurality of sub-intervals comprise: (i) a first sub-interval for dissemination of a verifier‑selected value to the plurality of sensor devices, (ii) a second sub-interval for dissemination of an encrypted attestation request to the plurality of sensor devices, (iii) a third sub-interval for key disclosure to the plurality of sensor devices, and (iv) a fourth sub-interval for aggregating responses received from the plurality of sensor devices.

The method may also include where storing the plurality of private values of the respective sensor device, the epoch time, and the disclosure delay time period includes transmitting, by the processor via a network to the respective sensor device, the plurality of private values of the respective sensor device, the epoch time, and the disclosure delay time period, and storing, by the respective sensor device in a memory of the sensor device, the plurality of private values of the respective sensor device, the epoch time, and the disclosure delay time period. Other technical features may be readily apparent to one skilled in the art from the following figures, descriptions, and claims. The method may also include where generating the unidirectional keychain includes generating, by the processor, each remaining key of the plurality of keys by applying the one-way hash function to the previous key in the unidirectional keychain. The method may also include where the secure element includes a microcontroller supporting a single thread of execution.

In some embodiments, a method comprises receiving, by a verification program of a first sensor device of a plurality of sensor devices and from a verifier device, a first message includes a message authentication code (MAC) and a first nonce value, the first MAC based on the first nonce value and a first key of a unidirectional keychain, receiving, by the verification program from the verifier device, a second message includes an encrypted attestation request and a second MAC, the second MAC based on a second key in the unidirectional keychain and the encrypted attestation request, the attestation request encrypted based on a request encryption key, receiving, by the verification program from the verifier device, the second key and a third key in the unidirectional keychain, verifying, by the verification program, the second key based on a determination that a hash of the third key equals the second key, generating, by the verification program, a second nonce value by hashing the first nonce value and a current nonce value stored by the first sensor device, deriving, by the verification program, the request encryption key by hashing the second key and the second nonce value, decrypting, by the verification program, the encrypted attestation request based on the request encryption key to yield a verifier array, determining, by the verification program based on a first index in the verifier array, to verify a device program in a memory of the first sensor device, where the first index is associated with the first sensor device, computing, by the verification program, a hash of the device program, computing, by the verification program, a third MAC of the hash of the device program and a prover key of the first sensor device, and determining, by the verification program, that the third MAC does not equal a fourth MAC stored by the first sensor device, the fourth MAC based on a predetermined hash of the device program and the prover key of the first sensor device.

The method may also include, based on the determination that the third MAC does not equal the fourth MAC, determining, by the verification program, that the device program of the first sensor device is not trusted. The method may also include further includes verifying, by the first sensor device, the first key based on a hash of the second key equaling the first key, and verifying, by the first sensor device, the first MAC based on a determination that a fifth MAC computed over the first nonce value using the first key equals the first MAC. The method may also include where the decryption of the request further yields a third nonce value, the method further includes prior to determining to computing the hash of the device program computing, by the verification program, a fourth nonce value based on a fifth MAC of the third nonce value and the first key, and storing, by the verification program, the fourth nonce as the current nonce value of the first sensor device. The method may also include where performing the corrective action includes one or more of: (i) the verification program refraining from transmitting a response to the verifier device, or (ii) the verification program transmitting an indication that the device program of the first sensor device is not trusted to the verifier device.

The method may also include further includes transmitting, by the verification program to the verifier device, an acknowledgement to build a spanning tree with the verifier device as a root node of the spanning tree. Other technical features may be readily apparent to one skilled in the art from the following figures, descriptions, and claims. The method may also include further includes computing, by the verification program, a sixth MAC based on the fifth MAC and the fourth nonce. The method may also include where the decryption of the request further yields a count of the plurality of sensor devices, the method further includes generating, by the verification program, a first array and a second array, where a size of the first array and a size of the second array are equal to the count of the plurality of sensor devices, where the first array includes a value of one at the index corresponding to the first sensor device and zeros at each remaining index, where the second array includes the sixth MAC at an index corresponding to the first sensor device, and transmitting, by the verification program, the first and second arrays to the verifier device. The method may also include further includes prior to transmitting the first and second arrays receiving, by the verification program from a second sensor device of the plurality of sensor devices, a third array and a fourth array, aggregating, by the verification program, the first array and the third array based on the OR function, thereby generating an aggregated first array, and aggregating, by the verification program, the second array and the fourth array based on the XOR function, thereby generating an aggregated second array, where the verification program transmits the aggregated first array and the aggregated second array to the verifier device. The method may also include where the first message is received at a first sub‑interval of a plurality of sub-intervals of an attestation phase, where the second message is received at a second sub‑interval of the plurality of sub-intervals, where the second key is received at a third sub‑interval of the plurality of sub-intervals, where the arrays are transmitted at a fourth sub‑interval of the plurality of sub-intervals. The method may also include where the first, second, third, and fourth sub-intervals comprise different lengths of time.

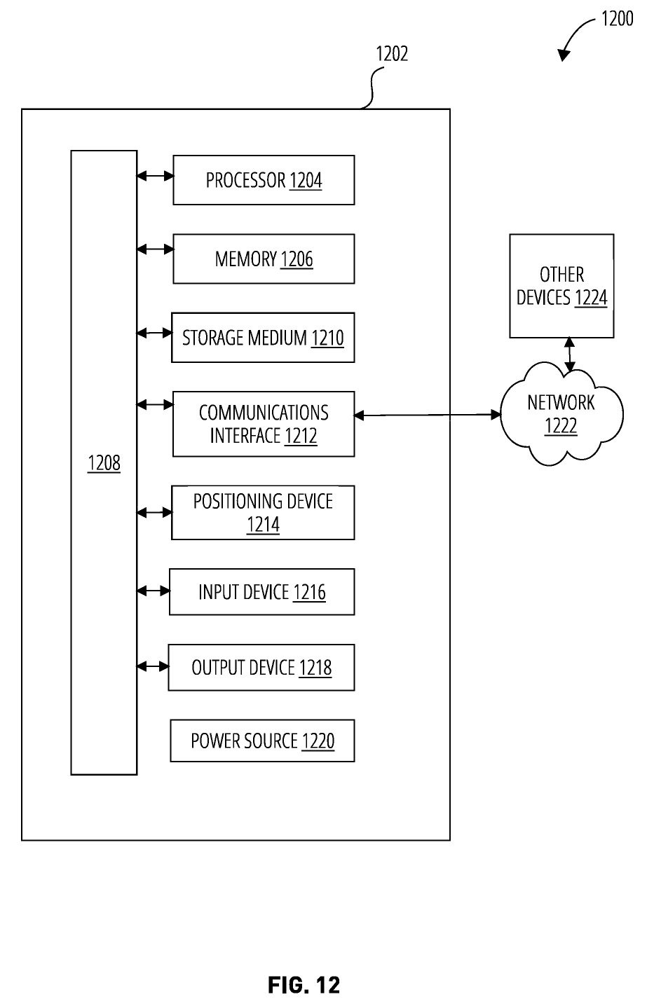

FIG. 12 illustrates an example computing system 1200 suitable for implementing various embodiments as described herein. As shown, the computing system 1200 comprises a computer 1202, which is representative of any type of physical and/or virtualized computing device. Examples of the computer 1202 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), container, or any other device with processing capabilities. In one embodiment, the computer 1202 is representative of some or all of the components of the computing device 102 and/or the sensor devices 104. More generally, the computing system 1200 is configured to implement all systems, methods, apparatuses, media, and embodiments disclosed herein.

As shown, the computer 1202 includes one or more processors 1204, one or more memories 1206, one or more non-transitory storage media 1210, one or more communications interfaces 1212, one or more positioning devices 1214, one or more input devices 1216, and one or more output devices 1218 communicably coupled via an interconnect 1208. A power source 1220, such as a power supply, battery, or any type of power source may provide power to the computer 1202.

The processor 1204 is representative of any type of processing circuit. For example, the processor 1204 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1206 is representative of any computer readable medium to store data, code, or other information. The memory 1206 may include volatile memory, such as volatile Random Access Memory (RAM) including a cache area for the temporary storage of data. The memory 1206 may also include non-volatile memory, which can be embedded and/or may be removable. The non-volatile memory can additionally or alternatively include an electrically erasable programmable read-only memory (EEPROM), flash memory or the like. The storage medium 1210 is representative of any type of computer readable medium to store data, code, or other information. Examples of storage media 1210 include solid state drives, hard drives, Redundant Array of Independent Disks (RAID) drives, memory pools, universal serial bus (USB) storage devices, and the like.

The memory 1206 and storage medium 1210 can store any number and type of computer-executable instructions executed by the processor 1204 to implement the functions of the computer 1202 described herein. For example, the memory 1206 may include the management application 108, device program 112, and/or verification program 114. Similarly, the memory 1206 and/or storage medium 1210 may be used to store data such as the verification repository 116, cached data, files for user accounts, user profiles, account balances, transaction histories, files downloaded or received from other devices, and any other data items.

The interconnect 1208 is representative of any type of circuitry to connect the components of the computer 1202. For example, the interconnect 1208 can include or represent, a system bus, a USB interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1204 to the memory 1206, individual electrical connections among the components, and electrical conductive traces on a motherboard common to some or all of the above-described components of the computer 1202. As discussed herein, the interconnect 1208 may operatively couple various components with one another, or in other words, electrically connects those components, either directly or indirectly – by way of intermediate component(s) - with one another.

The one or more input devices 1216 are representative of any type of input device for receiving input, such as a keypad, keyboard, touchscreen, touchpad, microphone, camera, fingerprint sensor, mouse, joystick, other pointer device, button, soft key, and the like. The one or more output devices 1218 are representative of any type of device for outputting information, such as a monitor, speaker, haptic feedback module, printer, and the like.

The computer 1202 may use the communications interface 1212 to communicate with one or more other devices 1224 via a network 1222. The communications interface 1212 allows the computer 1202 to communicate with and conduct transactions with other devices and systems, such as the other devices 1224. The communications interface 1212 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 1212, which can be or include a radio-frequency transceiver, a Bluetooth device, Wi-Fi device, a Near-Field Communication (NFC) device, and other wireless transceivers. In addition, a positioning device 1214 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 1212, e.g., using USB, Ethernet, and other physically connected modes of data transfer. The network 1222 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1202 is configured to use the communications interface 1212 as, for example, a network interface to communicate with one or more other devices on a network such as network 1222. In this regard, the computer 1202 utilizes the wireless communications interface 1212 as an antenna operatively coupled to a transmitter and a receiver (together a “transceiver”) included with the communications interface 1212. The communications interface 1212 is configured to provide signals to and receive signals from the transmitter and receiver, respectively. The signals may include signaling information in accordance with the air interface standard of the applicable cellular system of a wireless telephone network. In this regard, the computer 1202 may be configured to operate with one or more air interface standards, communication protocols, modulation types, and access types. By way of illustration, the computer 1202 may be configured to operate in accordance with any of a number of first, second, third, fourth, fifth-generation communication protocols and/or the like. For example, the as a smartphone, the computer 1202 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1202 may also be configured to operate in accordance with non-cellular communication mechanisms, such as via a wireless local area network (WLAN) or other communication/data networks.

The computer 1202 may be under the control of any suitable operating system (not pictured). Example operating systems include, but are not limited to, Linux® operating systems, UNIX®, Windows® operating systems, macOS®, iOS®, Android®, and any other type of operating system.

The computer 1202 as illustrated diagrammatically represents at least one example of a possible implementation, where alternatives, additions, and modifications are possible for performing some or all of the described methods, operations, and functions. Although shown separately, in some embodiments, two or more computers 1202, systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
generating, by a processor of a computing device based on a seed and a one-way hash function, a unidirectional keychain comprising a plurality of keys, wherein the seed is a first key of the plurality of keys and the remaining plurality of keys are based on the one-way hash function;
determining, by the processor based on an epoch time, a plurality of sub-intervals of time;
determining, by the processor, a disclosure delay time period;
generating, by the processor, a current nonce value;
determining, by the processor, a respective identifier for each sensor device of a plurality of sensor devices;
determining, by the processor for each sensor device, a respective plurality of private values, the plurality of private values comprising an authentication key, a prover key, a group key, a sensor nonce value and a hash value, wherein the group key is the last key in the unidirectional keychain; and
storing, by the processor in each respective sensor device, the plurality of private values of the respective sensor device, the epoch time, and the disclosure delay time period.

2. The method of claim 1, wherein generating the unidirectional keychain comprises:
applying, by the processor, the one-way hash function to the first key to generate a second key of the plurality of keys.

3. The method of claim 2, wherein generating the unidirectional keychain comprises:
generating, by the processor, each remaining key of the plurality of keys by applying the one-way hash function to the previous key in the unidirectional keychain.

4. The method of claim 1, wherein the disclosure delay time period is based on an amount of time required for transmission of data to the plurality of sensor devices via one or more networks.

5. The method of claim 1, further comprising:
determining, by the processor, the epoch time based on an amount of time required to perform a physical attack on the sensor devices.

6. The method of claim 1, wherein the plurality of private values of the respective sensor device, the epoch time, and the disclosure delay time period are stored in a secure memory region or a secure element of the respective sensor device.

7. The method of claim 6, wherein the secure element comprises a microcontroller supporting a single thread of execution.

8. The method of claim 1, wherein the plurality of sub-intervals comprise: (i) a first sub-interval for dissemination of a verifier‑selected value to the plurality of sensor devices, (ii) a second sub-interval for dissemination of an encrypted attestation request to the plurality of sensor devices, (iii) a third sub-interval for key disclosure to the plurality of sensor devices, and (iv) a fourth sub-interval for aggregating responses received from the plurality of sensor devices.

9. The method of claim 1, wherein storing the plurality of private values of the respective sensor device, the epoch time, and the disclosure delay time period comprises:
transmitting, by the processor via a network to the respective sensor device, the plurality of private values of the respective sensor device, the epoch time, and the disclosure delay time period; and
storing, by the respective sensor device in a memory of the sensor device, the plurality of private values of the respective sensor device, the epoch time, and the disclosure delay time period.

10. A non-transitory computer-readable storage medium, the computer-readable storage medium including instructions that when executed by a processor, cause the processor to:
generate, based on a seed and a one-way hash function, a unidirectional keychain comprising a plurality of keys, wherein the seed is a first key of the plurality of keys and the remaining plurality of keys are based on the one-way hash function;
determine, based on an epoch time, a plurality of sub-intervals of time;
determine a disclosure delay time period;
generate a current nonce value;
determine a respective identifier for each sensor device of a plurality of sensor devices;
determine, for each sensor device, a respective plurality of private values, the plurality of private values comprising an authentication key, a prover key, a group key, a sensor nonce value and a hash value, wherein the group key is the last key in the unidirectional keychain; and
store, in each respective sensor device, the plurality of private values of the respective sensor device, the epoch time, and the disclosure delay time period.

11. The computer-readable storage medium of claim 10, wherein the instructions to generate the unidirectional keychain comprises instructions that when executed by the processor, cause the processor to:
apply the one-way hash function to the first key to generate a second key of the plurality of keys.

12. The computer-readable storage medium of claim 11, wherein the instructions to generate the unidirectional keychain comprises instructions that when executed by the processor, cause the processor to:
generate each remaining key of the plurality of keys by applying the one-way hash function to the previous key in the unidirectional keychain.

13. The computer-readable storage medium of claim 10, including instructions that when executed by the processor, cause the processor to:
determine the disclosure delay time period based on an amount of time required for transmission of data to the plurality of sensor devices via one or more networks.

14. The computer-readable storage medium of claim 10, including instructions that when executed by the processor, cause the processor to:
determine the epoch time based on an amount of time required to perform a physical attack on the sensor devices.

15. The computer-readable storage medium of claim 10, wherein each key in the unidirectional keychain has a length of at least 256 bits, wherein the one-way hash function comprises a cryptographically secure hash function.

16. An apparatus, comprising:
a processor; and
a memory storing instructions that, when executed by the processor, cause the processor to:
generate, based on a seed and a one-way hash function, a unidirectional keychain comprising a plurality of keys, wherein the seed is a first key of the plurality of keys and the remaining plurality of keys are based on the one-way hash function;
determine, based on an epoch time, a plurality of sub-intervals of time;
determine a disclosure delay time period;
generate a current nonce value;
determine a respective identifier for each sensor device of a plurality of sensor devices;
determine, for each sensor device, a respective plurality of private values, the plurality of private values comprising an authentication key, a prover key, a group key, a sensor nonce value and a hash value, wherein the group key is the last key in the unidirectional keychain; and
store, in each respective sensor device, the plurality of private values of the respective sensor device, the epoch time, and the disclosure delay time period.

17. The apparatus of claim 16, wherein the instructions to generate the unidirectional keychain comprises instructions that when executed by the processor, cause the processor to:
apply the one-way hash function to the first key to generate a second key of the plurality of keys.

18. The apparatus of claim 17, wherein the instructions to generate the unidirectional keychain comprises instructions that when executed by the processor, cause the processor to:
generate each remaining key of the plurality of keys by applying the one-way hash function to the previous key in the unidirectional keychain.

19. The apparatus of claim 16, the memory storing instructions that, when executed by the processor, cause the processor to:
determine the disclosure delay time period based on an amount of time required for transmission of data to the plurality of sensor devices via one or more networks.

20. The apparatus of claim 16, the memory storing instructions that, when executed by the processor, cause the processor to:
determine the epoch time based on an amount of time required to perform a physical attack on the sensor devices.
